(19) United States
(12) Patent Application Publication
(10) Pub. No.: US 2024/0248189 A1
(43) Pub. Date: Jul. 25, 2024

(54) TARGETING SYSTEM FOR BISTATIC RADIO WAVE LOCALIZATION

(71) Applicant: Anduril Industries, Inc., Costa Mesa, CA (US)

(72) Inventor: Adnan Esmail, Mountain View, CA (US)

(21) Appl. No.: 18/207,767

(22) Filed: Jun. 9, 2023

Related U.S. Application Data
(60) Provisional application No. 63/440,188, filed on Jan. 20, 2023.

(51) Int. Cl. G01S 13/00; F41G 7/22; G01S 13/72

(52) U.S. Cl. CPC G01S 13/003; F41G 7/2266; F41G 7/2286; G01S 13/723

(57) ABSTRACT

The present application discloses a method, system, and computer system for tracking a target object. The method includes (i) receiving, by a receiver, an indication regarding a radio frequency (RF) transmitted beam, (ii) receiving a scattered reflection of the RF transmitted beam from a first target object, and (iii) processing the scattered reflection of the RF transmitted beam using the indication.

### CROSS REFERENCE TO OTHER APPLICATIONS

This application claims priority to U.S. Provisional Patent Application No. 63/440,188 entitled BISTATIC RADAR filed Jan. 20, 2023 which is incorporated herein by reference for all purposes.

### BACKGROUND OF THE INVENTION

Radio wave technology has been used for various applications including navigation, surveillance, and military applications. In particular, monostatic radars have been the most commonly used type of systems for such applications. Monostatic radars use a single antenna for both transmission and reception of electromagnetic waves. However, monostatic radars have certain limitations such as reduced detection range and susceptibility to interference from cluttering and jamming.

### BRIEF DESCRIPTION OF THE DRAWINGS

Various embodiments of the invention are disclosed in the following detailed description and the accompanying drawings.

FIG. 1 is a block a diagram of a network system according to various embodiments of the present application.

FIG. 2 is a block diagram of a transmitter system according to various embodiments of the present application.

FIG. 3 is a block diagram of a receiver system according to various embodiments of the present application.

FIG. 4 is a diagram of a target tracking system according to various embodiments of the present application.

FIG. 5 is a diagram illustrating a bistatic radio wave localization transmitter according to various embodiments of the present application.

FIG. 6 is a diagram illustrating a local on-board radio detection system receiver according to various embodiments of the present application.

FIG. 7 is a diagram illustrating a bistatic radio wave localization transmitter according to various embodiments of the present application.

FIG. 8 is a diagram illustrating a bistatic radio wave localization transmitter antenna array according to various embodiments of the present application.

FIG. 9A is a diagram illustrating characteristics for a bistatic radio wave localization transmitter according to various embodiments of the present application.

FIG. 9B is a diagram illustrating characteristics for a bistatic radio wave localization transmitter according to various embodiments of the present application.

FIG. 9C is a diagram illustrating characteristics for a bistatic radio wave localization transmitter according to various embodiments of the present application.

FIG. 10 is a diagram illustrating a receiver according to various embodiments of the present application.

FIG. 11 is a flow diagram of a method for detecting objects according to various embodiments of the present application.

FIG. 12 is a flow diagram of a method for tracking a target object according to various embodiments of the present application.

FIG. 13 is a flow diagram of a method for providing an indication regarding a radio frequency (RF) transmitted beam and/or a target object according to various embodiments of the present application.

FIG. 14 is a flow diagram of a method for providing an indication regarding an RF transmitted beam and/or a target object according to various embodiments of the present application.

FIG. 15 is a flow diagram of a method for tracking an object based at least in part on an RF transmitted beam transmitted by a transmitter according to various embodiments of the present application.

FIG. 16 is a flow diagram of a method for controlling an interceptor based at least in part on an RF transmitted beam transmitted by a transmitter according to various embodiments of the present application.

FIG. 17 is a flow diagram of a method for performing an active measure with respect to a target object being tracked by a bistatic radio wave localization system according to various embodiments of the present application.

FIG. 18 is a flow diagram illustrating an embodiment of a process for determining guidance of an interceptor.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Bistatic radio wave localization is an emerging technology that overcomes some of the limitations of monostatic radar systems. A bistatic radio wave localization system comprises two separate antennas for transmitting and receiving the electromagnetic waves (e.g., one for generating a radio frequency (RF) beam directed to an object and one for receiving the RF beam reflected from the object). The separation of antennas enables a bistatic radio wave localization system to detect and track objects that are beyond the range of a monostatic radar system. In addition, in some embodiments, the separation of the transmitting beam as situated in a ground-based station and a receiver as situated in a flying object enables implementation of the two devices with a higher cost high power transmitting beam in the ground-based station and a lower cost receiver in the flying object. Moreover, bistatic radio wave localization systems are less susceptible to interference from clutter and jamming.

One of the applications of bistatic radio wave localization systems is in tracking and intercepting objects such as missiles and other airborne threats. Bistatic radio wave localization systems can provide more accurate and reliable tracking information pertaining to the object(s) being tracked, which may be used for intercepting target objects.

Various embodiments include a method, system, and/or device for tracking a target object. The method includes (i) providing, by a transmitter, an RF transmitted beam toward a target object, and (ii) providing an indication regarding one or more of the RF transmitted beam and the target object.

Various embodiments include a method, system, and/or device for tracking a target object. The method includes (i) receiving, by a receiver, an indication regarding an RF transmitted beam, (ii) receiving a scattered reflection of the RF transmitted beam from a first target object, and (iii) processing the scattered reflection of the RF beam using the indication.

According to various embodiments, the system comprises at least one transmitter configured to track target objects and illuminate one or more of the target objects with an RF beam. For example, the at least one transmitter is configured to transmit the RF beam directed towards at least one of the one or more target objects. The system further comprises at least one receiver, such as a receiver comprised in an interceptor. The receiver is configured to detect the RF beam scattered/reflected by a target object. The transmitter provides information pertaining to the RF beam (e.g., the beam transmitted towards the target object) and/or the target object. As an example, the transmitter modulates information pertaining to the RF beam and/or one or more target objects. As another example, the transmitter sends the information pertaining to the RF beam and/or one or more target objects to the receiver over an established communication channel (e.g., a direct communication link or a network connection). The interceptor comprising the receiver can use the information pertaining to the RF beam and/or one or more target objects in connection with controlling navigation of the interceptor or determining whether to perform an active measure and causing the active measure to be performed if so determined.

Traditionally, seekers using radar systems to identify and seek out objects are very expensive. For example, such seekers rely on an expensive ground radar that communicates to the seeker (e.g., an airborne interceptor) where another airborne object is located. As another example, related art seekers need high power to capture reflective energy and for cooling. In some embodiments, the seeker (e.g., the interceptor configured with the receiver) uses passive detection of the RF beam scattered from a target object to track the target object. The use of the bistatic radio wave localization system as disclosed herein provides a more efficient (e.g., cost effective) system that has greater accuracy. For example, the bistatic radio wave localization system transitions target tracking to a high frequency RF band to transmit/receive signals that ping in a narrow beam form. Rather than using a camera to track an object, various embodiments use a radar with a tight beam form in order to attain a high fidelity tracking of the object. The narrow beam form allows the interceptor (e.g., an aircraft) to determine the location of the target object or the direction in which the object is moving. As the center of the beam form moves, the interceptor detects the movement of the beam form and tracks the object. Accordingly, the use of a transmitter to illuminate a target object using a tight beam form RF beam enables the interceptor to perform fast or immediate tracking of the target object.

According to various embodiments, the bistatic radio wave localization system is configured to have a separate detection system (e.g., a monostatic radar, a bistatic radar, a passive radar, an imaging system, etc.) that provides a track to an interceptor to head off toward. The track derived from the detection system is used to guide an interceptor to a target. In some embodiments, the detection system is able to detect the target at distances of at least between 10-25 km away. The detection system guides the interceptor to within a volume approximately 2 km away from the target. At that point the bistatic radio wave localization system is used to illuminate the target for a receiver on the interceptor. The transmitter antenna for the bistatic radio wave localization system is mounted on a tower and is dynamically (e.g., continuously) directed to the target object by a pan tilt unit (PTU) during object tracking. The receiver system (e.g., the receiver onboard the interceptor) has a finite range that depends on the target cross section (e.g., the finite range is designed to be approximately 2 km). For example, the receiver on the interceptor receives/acquires the transmitted signal reflected from the target object within the 2 km range. The receiver is configured to have a field of view of 50 degrees. The receiver has a form factor with an antenna size of about 12 cm×12 cm (e.g., 115.5 mm×116.3 mm). The bistatic radio wave localization system has an angular resolution of 5-10 degrees (e.g., 6.3 degrees) and an angular accuracy of less than 1 degree. An example of the radio wave localization system refresh rate is 15 Hz but may be configured based on processing gains and angular accuracy considerations.

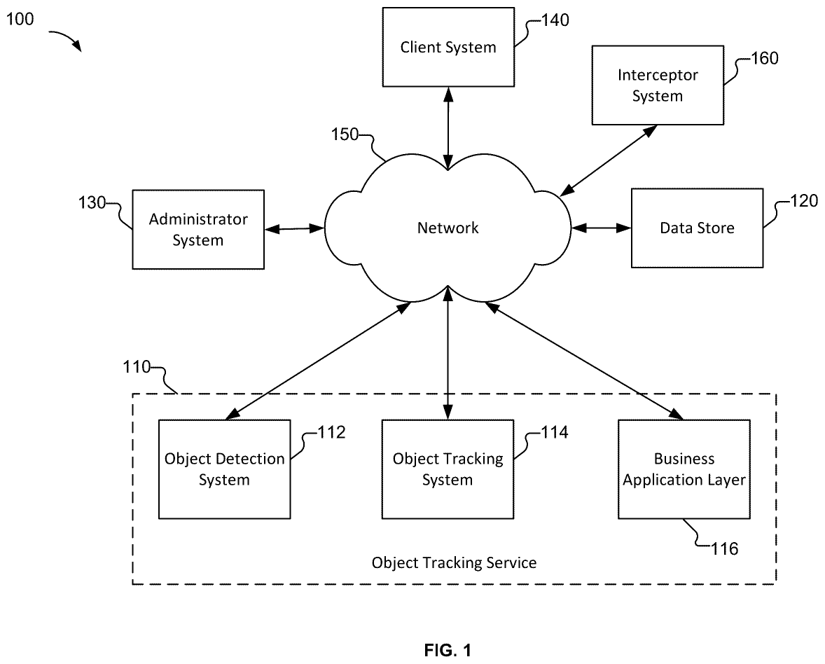

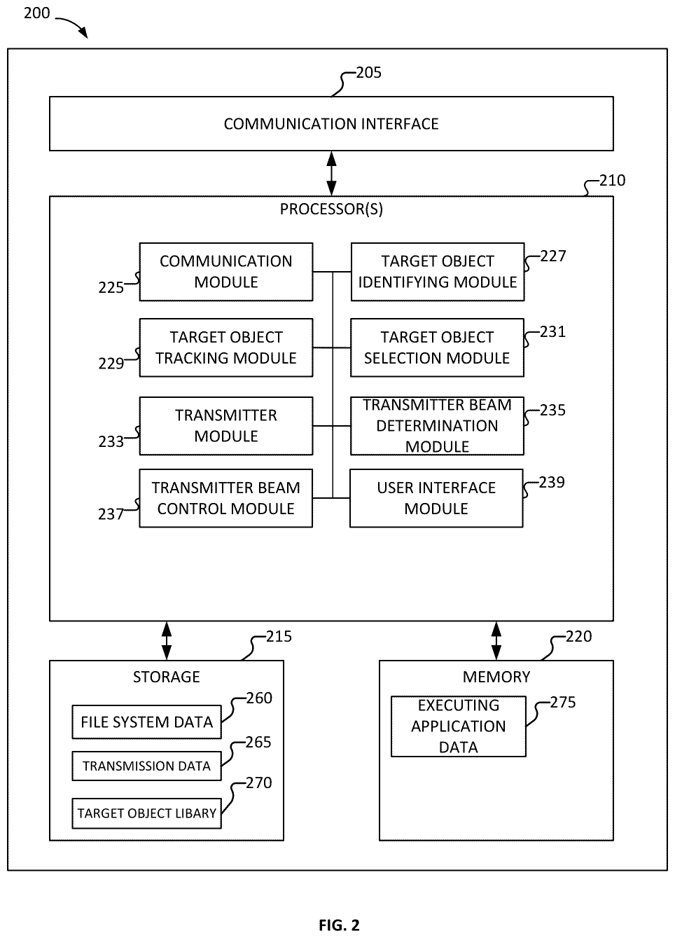

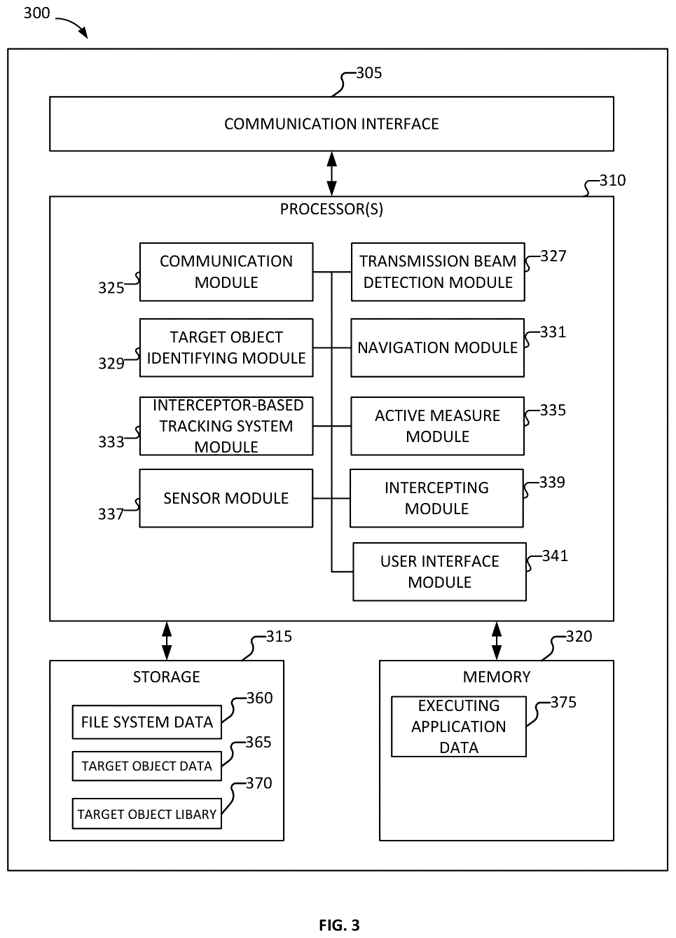

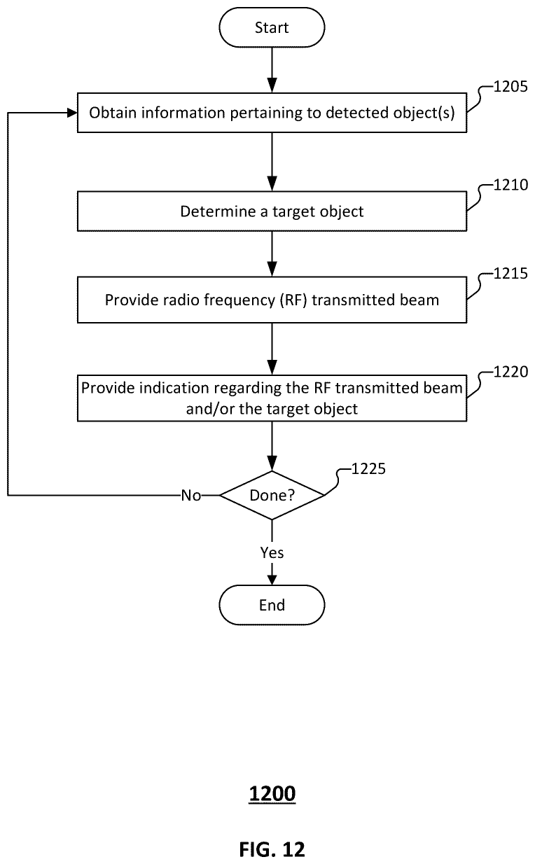

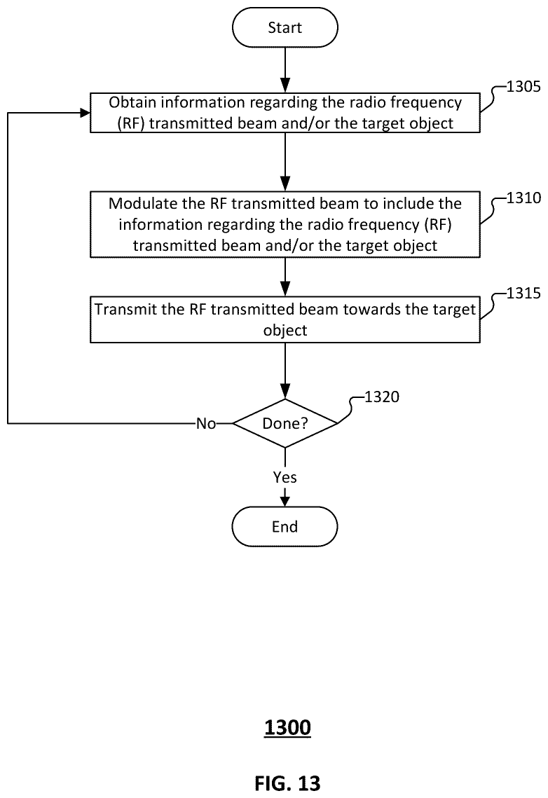

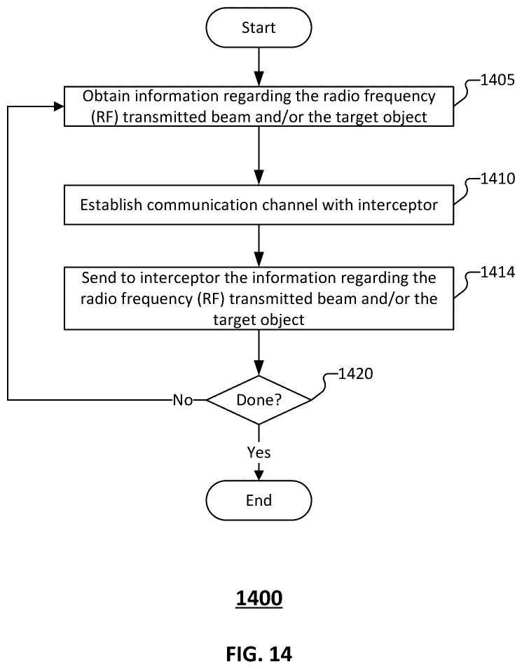

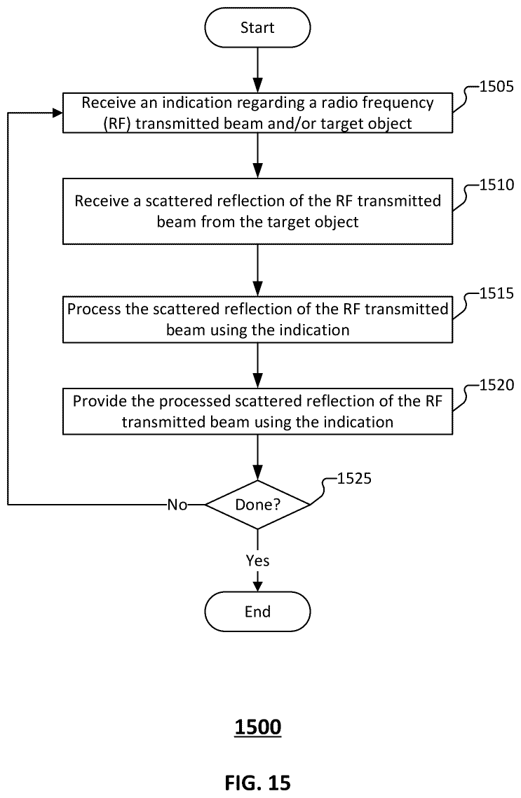

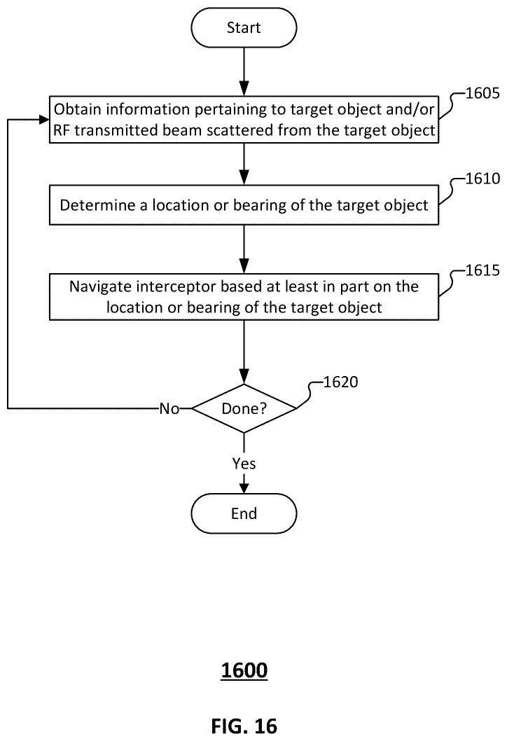

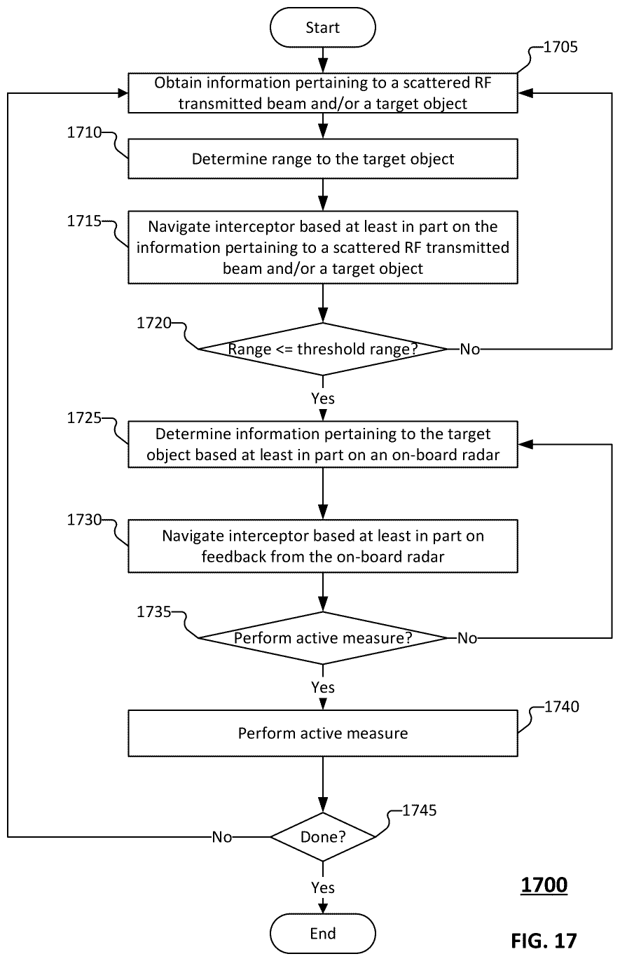

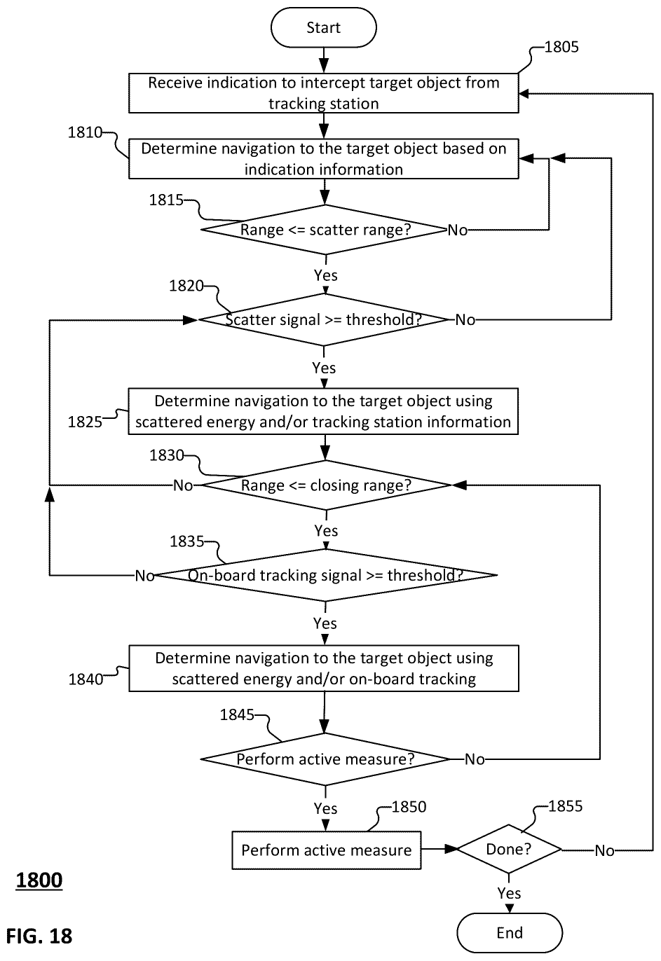

FIG. 1 is a block diagram of a network system according to various embodiments of the present application. According to various embodiments, system 100 is implemented at least in part by system 200 of FIG. 2 and/or system 300 of FIG. 3. In some embodiments, system 100 implements at least part of process 1200 of FIG. 12, process 1300 of FIG. 13, process 1400 of FIG. 14, process 1500 of FIG. 15, process 1600 of FIG. 16, process 1700 of FIG. 17, and/or process 1800 of FIG. 18.

In the example illustrated in FIG. 1, system 100 includes object tracking service 110, data store 120, and/or interceptor system 160. System 100 may additionally include administrator system 130, client system 140 and network 150 over which one or more of object tracking service 110, data store 120, administrator system 130, and client system 140 are connected. Object tracking service 110 and interceptor system 160 may be connected via network 150 or via a direct connection link. In some embodiments, object tracking service 110 is implemented by a plurality of servers. In various embodiments, network 150 includes one or more of a wired network, and/or a wireless network such as a cellular network, a wireless local area network (WLAN), or any other appropriate network. System 100 may include various other systems or terminals.

System 100 may additionally include a detection system (e.g., a monostatic radar, a bistatic radar, a passive radar, an imaging system, etc.) (not shown). For example, object detection system 112 may comprise the detection system or may be configured to receive from the detection system information pertaining to the detection of objects. In some embodiments, a detection system (e.g., a monostatic radar, a bistatic radar, a passive radar, an imaging system, etc.) is separate and able to provide system 100 with data regarding objects.

In the example shown, object tracking service 110 comprises object detection system 112, object tracking system 114, and/or business application layer 116. One or more of object detection system 112, object tracking system 114, and/or business application layer 116 may be implemented by a same device (e.g., computer/server) or by a plurality of devices (e.g., a plurality of servers or cluster of machines).

Object detection system 112 determines information pertaining to one or more detected objects, such as objects within a predetermined area. Object detection system 112 may comprise a radar system (e.g., a monostatic radar system, a bistatic radar system, a passive radar system, etc.) or an imaging system (e.g., a visual camera, an infrared imaging system, etc.) that detects the presence of objects within the predetermined area, or object detection system 112 obtains information pertaining to detected objects from an external detection system (e.g., a monostatic radar system, a bistatic radar system, a passive radar system, an imaging system, etc.). In response to object tracking service 110 (e.g., object detection system 112) determining that an object is detected, object tracking service 110 interrogates the one or more detected objects to determine whether the object is to be tracked or intercepted. For example, object tracking service 110 determines whether the object is a benign or friendly object, the object is malicious or an enemy object, or the object is to be surveilled such as in the case that the object is unknown (e.g., is not known to be benign or malicious) or otherwise does not match a predefined object template. Through the interrogating of the one or more detected objects, object tracking service 110 determines one or more target objects to be tracked. The one or more target objects may be a subset of the one or more detected objects. In some embodiments, object tracking service 110 uses a camera in connection with interrogating a detected object. For example, object tracking service 110 uses the camera to determine whether the object is a bird, a drone, etc.

In the case that the set of detected objects are interrogated and a plurality of target objects are identified, object tracking service 110 (e.g., object detection system 112 or object tracking system 114) may determine to track one or more of the target objects. Object tracking service 110 determines respective priorities for the plurality of target objects. In some embodiments, object tracking service 110 applies one or more priority policies in connection with determining priorities for the plurality of target objects. A priority policy may be predefined, such as by an administrator of system 100. The priority policy defines one or more parameters of functions for determining a priority. As an example, the priorities for the target objects may be determined based at least in part on one or more of: respective locations of the target objects, respective distances between the target objects and another location such as a location at which object tracking service 110 is deployed or a location of an interceptor (e.g., interceptor system 160), an indication that a target object is malicious, a target object type (e.g., a surveillance aircraft, an attacking aircraft, etc.), a characteristic pertaining to a target object (e.g., size, speed, equipment), etc.

In response to determining the respective priorities for the target objects, object tracking service 110 determines, from the set of target objects, the one or more target objects to track (e.g., using object tracking system 114). In response to determining the one or more target objects to track, object tracking system 114 configures an energy beam to be directed towards at least one of the target objects. The energy beam may be an RF beam, an infrared beam, a UV beam, etc. Various other types of energy may be directed toward the target object(s) to effectively paint or illuminate the target object(s) with such energy (e.g., which may be detected via detecting scattering reflected from the target object(s)).

In some embodiments, the energy beam is an RF beam. The RF beam has a frequency (e.g., a cycle frequency) between 2 GHz and 50 GHz. As an example, generally, the higher the frequency of the RF beam, the greater the energy required to transmit the RF beam. In some embodiments, the frequency of the RF beam directed towards a target object is 20-40 GHz. In some embodiments, the frequency of the RF beam directed towards a target object is 20-35 GHz. In some embodiments, the frequency of the RF beam is about 24 GHz. In some embodiments, the selection of the RF beam frequency is optimized for availability of commercially off the shelf (COTS) chipsets (automotive) and the right matching of medium loss characteristics and field of view (FOV) and angular resolution to get to the system's accuracy design goals.

In some embodiments, the energy beam (e.g., the RF beam) is generated/transmitted in a narrow beam form. Traditional beams used to track objects generally extend 10-15 degrees. Accordingly, traditional beams require relatively large amounts of energy to track the objects. In contrast, according to various embodiments, the energy beam extends less than 10 degrees. In some embodiments, the energy beam (e.g., the RF beam) extends a fraction of a degree. Thus, various embodiments are energy efficient and highly accurate mechanisms for tracking target objects.

As the target object being tracked moves, object tracking service 110 updates the direction of the energy beam. For example, object tracking service 110 (e.g., object detection system 112) obtains an updated location for the target object and in response to determining that the target object has moved, object tracking service 110 (e.g., object tracking system 114) updates the direction of the energy beam to ensure that the target object continues to be painted/illuminated with the energy beam. In some embodiments, a mechanically steered pan and tilt unit (PTU) is used to point the transmitter and follow the target, and this steered to pointing direction information of the PTU is then used to provide information for updating the direction of the energy beam. In some embodiments, the system uses an active electronically scanned array (AESA) to track the target to provide information for updating the direction of the energy beam.

In some embodiments, the target object is tracked using a a detection system at first range (e.g., the first range is 10-25 km from a tracking station transmission system to an object—for example, a monostatic system, a bistatic radar system, a passive radar system, an imaging system, etc.), the target object is tracked using an energy beam reflected from the object and detected by an interceptor receiver at a second range between the object and the interceptor (e.g., the second range is 2 km or less between the interceptor and the object), and the target object is tracked using an interceptor-based tracking system (e.g., a greater than 24 GHz frequency—for example, 77 GHz interceptor based tracking system; In some embodiments, the selection of the interceptor-based tracking system frequency is optimized for availability of commercially off the shelf (COTS) chipsets and the right matching of medium loss characteristics and field of view (FOV) and angular resolution to get to the system's accuracy design goals) at a third range between the object and the interceptor (e.g., the third range is less than 300 m from the interceptor to the object).

In some embodiments, object tracking service 110 dynamically updates the locations of the target objects, adds new target objects based on updated detection information, removes target objects based on updated detection information (e.g., the determination that a particular target object has moved out of range or otherwise to a location/range that is not concerning to object tracking service 110), etc. In some embodiments, object tracking service 110 uses a combination of a detection system (e.g., a monostatic radar system, a bistatic radar system, a passive radar system, an imaging system etc.), an energy beam/interceptor detection system, and an interceptor-based tracking system to guide an interceptor to a target object. In some embodiments, the tracking of the object is guided first from the tracking station information (e.g., from the detection system) and then second from the interceptor (e.g., first using the detection of the energy beam and then as closer to the object the local tracking system). In response to the update to the target objects, object tracking service 110 dynamically re-prioritizes the target objects, such as according to one or more priority policies. Object tracking system 114 may configure the energy beam based at least in part on the updated re-prioritization of the target objects. For example, if object tracking system 114 determines to track a target object different from the target object(s) being tracked, object tracking system 114 re-configures (e.g., re-directs) the energy beam accordingly.

Object tracking service 110 can track a plurality of target objects simultaneously or serially. The simultaneous tracking of the plurality of target objects may include transmitting a plurality of RF beams respectively directed at different target objects. For example, object tracking system 114 comprises one or more detection systems and one or more energy beam transmitters which may be respectively configured to transmit different RF beams that are each directed to different target objects. As an example, object tracking system 114 may track a first set of two or more target objects using a first RF beam (e.g., transmitted by a first transmitter) and a second set of two or more target objects using a second RF beam (e.g., transmitted by a second transmitter). Additionally, or alternatively, the simultaneous tracking of the plurality of target objects may include tracking two or more target objects (e.g., in the event of a swarm of target objects) using a single RF beam that is modulated or duty cycled to direct at least part of the RF beam to the two or more target objects to be tracked using the single RF beam. The duty cycling may be performed at the order of seconds or tenths of seconds. For example, multiple target objects may be painted/illuminated with different modulations or patterns of the RF beam.

In some embodiments, the RF beam transmitted by a transmitter comprised in object tracking system 114 is modulated using one or more of a frequency modulation, a phase modulation, an amplitude modulation, a shift modulation, and/or a chirp modulation. As an example, a first modulation of the RF beam is directed to the first target object, and a second modulation of the RF beam is directed to a second target object.

In connection with tracking a target object(s) using an energy beam (e.g., an RF beam), object tracking service 110 provides information pertaining to the target object and/or energy signal/beam to a receiver such as interceptor system 160. In some embodiments, the information pertaining to the target object comprises one or more of a position, a heading, an identifier, a type, a first detected location, a velocity, a speed, a speed toward or away from the transmitter, a speed perpendicular from the transmitter, etc. Interceptor system 160 uses the information pertaining to the target object and or energy signal/beam to track the applicable target object(s), such as to surveil, intercept, and/or engage the target object(s). In some embodiments, an indication of the information pertaining to the target object and/or RF beam is communicated via a communication channel established between the transmitter (e.g., object tracking system 114) and the receiver (e.g., interceptor system 160). The communication channel may be a network connection or a direct link between transmitter and receiver. Additionally, or alternatively, the indication of the information pertaining to the target object and/or RF beam is carried in the RF beam itself. For example, object tracking system 114 modulates the RF beam to comprise the indication of the information pertaining to the target object and/or RF beam (e.g., in a particular modulation of the modulated RF beam). The modulation of the RF beam to include the indication of the information pertaining to the target object and/or RF beam enables a robust/resilient tracking system. Network communication channels are susceptible to jamming or other interference. Thus, by modulating the RF beam to include the information pertaining to the target object or RF beam, object tracking service 110 is able to robustly communicate information to interceptor system 160 in the absence of a communication channel or in the event of a jamming of the communication channel. Accordingly, interceptor system 160 is able to robustly track the target object(s) by following the RF beam in the absence of a communication channel or in the event of a jamming of the communication channel.

Object tracking service 110 (e.g., object tracking system 114) may be deployed on the ground, airborne (e.g., mounted on or comprised in an aircraft), or at sea (e.g., mounted on or comprised in a ship).

In some embodiments, system 100 comprises one or more receivers, such as interceptor system 160. Interceptor system 160 may be airborne, such as a drone (e.g., an autonomous drone) or other aircraft. Although examples described herein include an interceptor (e.g., interceptor system 160) that is airborne, the interceptor may be ground-based or sea-based. A receiver is configured to detect energy beams, such as an RF beam. For example, the receiver obtains scattering of the RF beam transmitted by a transmitter, such as parts of the RF beam that are reflected from the target object. In some embodiments, the receiver is configured to detect energy beams (e.g., RF beams) having a specific energy level, such as a particular frequency or range of frequencies.

In some embodiments, the receiver has a 30-60 degree view. The relatively large field of view enables interceptor system 160 to comprise the receiver without the receiver being mounted to a gimble. In contrast, related art systems have narrow fields of view and thus require expensive gimbles to enable the interceptor to effectively detect objects at a long range.

The sensor data (e.g., RF beam) detected by interceptor system 160 may be subject to noise/interference. For example, at high amplitudes, interceptor system 160 accumulates a significant amount of ground clutter. The ground clutter may be so significant that the clutter overwhelms the receiver.

The receiver (e.g., interceptor system 160) is configured to process information pertaining to a detected energy beam (e.g., the RF beam). For example, the receiver processes the detected energy (e.g., the RF beam information) to remove (e.g., filter out) clutter reflected from the environment, such as the ground. In some embodiments, the received energy beam signal is analyzed using spectral analysis (e.g., a Fourier transform of the frequencies received). In some embodiments, the received energy beam signal scattered from the target object is analyzed using Doppler analysis (e.g., by performing a Fourier transform) and the signal from the target object is isolated by filtering out the signals from the background environment as they are distinct in Doppler space. In some embodiments, the signals from the target and from the background landscape are distinct in the spectral analysis space (e.g., frequency space) because they have different Doppler shifts and can be filtered to remove the background landscape contribution to the signal. In some embodiments, the receiver obtains Doppler information. The receiver uses the Doppler information to detect the target object. For example, the receiver views the Doppler space and obtains information pertaining to the target object (e.g., the object is moving at a different speed relative to the interceptor). Accordingly, the receiver detects the object moving relative to the ground/environment.

According to various embodiments, interceptor system 160 is controlled, or is navigated, based at least in part on the scattered energy (e.g., the scattered RF beam reflected from the target object(s)). Interceptor system 160 may be controlled, or is navigated, based on a detection system (e.g., a monostatic radar system, a bistatic radar system, a passive radar system, an imaging system, etc.). Interceptor system 160 may be controlled based on the scattered energy to approach the target object, surveil, intercept, and/or eliminate the target object. Interceptor system 160 may be controlled based on a detection system to approach the target object, surveil, intercept, and/or eliminate the target object. Interceptor system 160 is navigated based on information from a detection system or scattered energy to intercept the target object, such as to approach the target object to move within a predefined range or distance of the target object from which the scattered energy (e.g., the RF beam or a local beam source) is reflected. For example, interceptor system 160 follows the scattered energy and moves towards the target object from which the energy beam is scattered. Interceptor system 160 may comprise a filter (e.g., a notch filter) to identify the energy beam and the receiver finds the hot spot in the environment (e.g., the hot spot in the sky corresponding to the target object painted/illuminated by the RF beam transmitted by the transmitter of object tracking system 114).

Interceptor system 160 dynamically (e.g., continuously) monitors the energy detected by the receiver and adjusts course accordingly. Interceptor system 160 determines a distance to the target object. In response to determining that the target object is within a predefined range, interceptor system 160 may switch to a different local tracking system or sensor for tracking the target object. In some embodiments, the different local tracking system or other sensor is an interceptor-based tracking system (e.g., a local on-board radio detection system), such as a low power directional radar (e.g., a radar operating at 77 GHz). In some embodiments, the predefined range is 300 m. In some embodiments, the predefined range is 350 m. In some embodiments, the predefined range is less than 500 m.

According to various embodiments, interceptor system 160 navigates towards the target object based on information communicated by a pan tilt unit (PTU), such as at a ground station or object tracking service (e.g., target bearing and distance information conveyed over a communication link between the PTU, or object tracking service 110 and interceptor system 160). For example, interceptor system 160 uses telemetry data received from the PTU to navigate towards the target object. When interceptor system 160 is within range of the target object, interceptor system 160 switches to navigation based on detected energy (e.g., an RF beam) scattered from the target object. As an example, interceptor system 160 relies on telemetry data provided by the PTU until interceptor system 160 is within about 2 km of the target object at which point interceptor system 160 uses the energy scattered from the target object to navigate to the target object. In various embodiments, the PTU includes a visual, a RF, a monostatic radar, a passive radar, a bistatic radar, an infrared, an imaging system, or any other appropriate detection system.

According to various embodiments, business application layer 116 provides an interface via which a user (e.g., using client system 140) may interact with various applications such as a development application for developing a service, application, and/or code, an application to access raw data (e.g., data stored in data store 120), an application to analyze data (e.g., sensor data), etc. Various other applications can be provided by business application layer 116. As another example, an administrator uses an interface provided/configured by business application layer 116 to configure (e.g., define) one or more policies such as tracking policies, priority policies, or security policies including access permissions to information stored on a data store 120, permission to access performance profiles, etc.

Administrator system 130 is a system by which an administrator uses or manages object tracking service 110. For example, administrator system 130 comprises a system for communication, data access, computation, etc. An administrator uses administrator system 130 to maintain and/or configure object tracking service 110 and/or data store 120. For example, an administrator uses administrator system 130 to start and/or stop services on object tracking service 110 (e.g., a detection service, a tracking service, etc.) and/or data store 120, to reboot data store 120, to install software on object tracking service 110 and/or data store 120, to add, modify, and/or remove data on data store 120, etc. Administrator system 130 communicates with object tracking service 110 and/or data store 120 via a web-interface. For example, administrator system 130 communicates with object tracking service 110 and/or data store 120 via a web-browser installed on administrator system 130. As an example, administrator system 130 communicates with object tracking service 110 and/or data store 120 via an application running on administrator system 130.

In some embodiments, business application layer 116 serves as a gateway via which the administrator may interface to manage, configure, etc. object detection system 112, object tracking system 114, and/or business application layer 116.

Data store 120 stores one or more datasets. In various embodiments, the one or more datasets comprise detection data, tracking data, or target object data. Additionally, the one or more datasets may include datasets pertaining to active measures to be implemented in response to object detection/interception, or any other appropriate data. Data store 120 comprises a database system for storing data in a table-based data structure, an object-based data structure, etc.

According to various embodiments, a user uses system 100 (e.g., a client or terminal, such as client system 140, that connects to system 100 via network 150) to execute one or more tasks with respect to data (e.g., one or more datasets) stored on data store 120. For example, a user inputs to a client terminal a query or request to execute an object tracking and/or an object detection, and object tracking service 110 receives the query or request to execute the object tracking or object detection from client system 140 via network 150, etc. In response to receiving the query or request to execute the task, object tracking service 110 uses object detection system 112 to execute the object detection or object tracking system 114 to execute a tracking of a detected object and provides a result to the user (e.g., via the client terminal).

In some embodiments, in response to detecting an object, system 100 determines whether to perform an active measure based on such detection and object tracking. As an example, in response to interceptor system 160 intercepting the target object or travelling within a certain range of the target object, system 100 determines whether to perform an active measure. In response to determining to perform an active measure, system 100 implements the active measure or causes another system or service to implement the active measure (e.g., system 100 provides an indication that an active measure is to be performed, or interceptor system 160 determines the active measure and implements the active measure). Examples of active measures include providing an indication that an object is detected, surveilling the target object, eliminating the target object, intercepting the target object, jamming sensors comprised in the target object, etc. In some embodiments, system 100 determines the active measure to implement (if any) based on a mapping of objects (e.g., types of objects, object identifiers, etc.) to active measures.

FIG. 2 is a block diagram of a transmitter system according to various embodiments of the present application. In some embodiments, system 200 implements at least part of system 100 of FIG. 1, such as object tracking service 110 or object tracking system 114.

According to various embodiments, system 200 corresponds to, or comprises, a system for tracking an object, such as an object detected by a detection system (e.g., a monostatic radar system, a bistatic radar system, a passive radar system, an imaging system, etc.). System 200 may be configured to paint/illuminate a target object using an energy beam (e.g., an RF beam, such as a high-powered RF beam having a frequency of 20-40 GHz). Additionally, system 200 may determine an active measure and/or cause an active measure to be implemented in response to determining that an object is detected in sensor data or otherwise intercepted by an interceptor (e.g., a receiver with which system 200 communicates).

In the example shown, system 200 implements one or more modules in connection with performing object detection and providing tracking information for tracking the target object, etc. System 200 comprises communication interface 205, one or more processors 210, storage 215, and/or memory 220. One or more processors 210 comprises one or more of communication module 225, target object identifying module 227, target object tracking module 229, target object selection module 231, transmitter module 233, transmitter beam determination module 235, transmitter beam control module 237, and/or user interface module 239.

In some embodiments, system 200 comprises communication module 225. System 200 uses communication module 225 to communicate with various other systems, such as interceptors, aircraft, other associated vehicles (e.g., ground-based or sea-based vehicles), client terminals or an administrator system, or other modules of system 100 such as an object detection system 112, object tracking system 114, data store 120, etc. Communication module 225 provides to communication interface 205 information that is to be communicated. As another example, communication interface 205 provides to communication module 225 information received by system 200. Communication module 225 is configured to receive one or more queries or requests to execute tasks (e.g., requests for tracking an object, requests for implementing an active measure, setting an active measure policy, priority policy, tracking policy, etc.) such as from various client terminals or user systems (e.g., from administrator system 130 or client system 140 via business application layer 116). The one or more queries or requests to execute tasks may be with respect to information stored in one or more datasets (e.g., data stored in data store 120, such as datasets pertaining to tracked objects, detected objects, mission information for intercepting or performing active measures with respect to tracked objects, etc.). Communication module 225 is configured to provide to various client terminals, or other systems, an indication of the object that a receiver is configured to detect using scattered portions of the RF beam and/or a local detection system.

In some embodiments, system 200 comprises target object identifying module 227. System 200 uses target object identifying module 227 to identify the one or more target objects in response to obtaining information pertaining to a detected object(s). For example, target object identifying module 227 receives an indication that a radar or camera system detected an object(s) within a range being monitored. Target object identifying module 227 receives an indication of which detected object(s) are to be tracked or target object identifying module 227 interrogates the set of detected objects to determine the one or more target objects (e.g., a subset of the detected objects). As an example, target object identifying module 227 determines whether to track an object (e.g., paint/illuminate with an RF beam and intercept using an interceptor) based on identifying the detected object(s) and/or identifying a type of object. Target object identifying module 227 may determine to track a detected object based at least in part on interrogating whether the detected object is benign (e.g., a bird, a civilian drone, a civilian plane), malicious (e.g., an enemy drone, an enemy plane), or unknown (e.g., system 200 is unable to determine an identifier or object type for the detected object). In various embodiments, the determination of whether to track a detected object is based on one or more of the following: a determination of a visual profile, a determination of a radio emission profile, a determination of a flight pattern characteristic, a determination of a size, a determination of a color, a determination of a speed, or any other appropriate determination. In response to identifying the one or more target objects, target object identifying module 227 provides an indication of the target object(s) to be tracked (e.g., to target object tracking module 229 or target object selection module 231, etc.).

In some embodiments, system 200 comprises target object tracking module 229. System 200 uses target object tracking module 229 to coordinate the tracking of one or more target objects. In response to determining the one or more target objects to be tracked (e.g., by target object identifying module 227), target object tracking module 229 invokes targe object selection module 231, transmitter module 233, transmitter beam determination module 235, and/or transmitter beam control module 237 to track at least one of the one or more target objects to be tracked. Target object tracking module 229 determines a target object(s) to be tracked, a priority of target objects to be tracked, a manner by which the target object(s) is to be tracked, etc. In various embodiments, a decision of which objects to track is based on one or more of the following: a local object risk assessment, a collaborative object risk assessment, a local ranking of object risks, a collaborative ranking of object risks, a user indication, or any other appropriate decision appropriate decision factor.

In some embodiments, in response to determining that a plurality of the detected objects correspond to target objects (e.g., objects that are to be subject to tracking by system 200 and/or one or more other such systems), target object tracking module 229 determines respective priorities for the plurality of target objects. The respective priorities may be determined based at least in part on one or more priority policies. Target object tracking module 229 then uses target object selection module 231 to select one or more of the target objects to be tracked with an energy beam transmitted by transmitter module 233. In some embodiments, target objects that are tracked are assigned an interceptor (e.g., an interceptor is provided instructions to intercept or to move close to the target object). In response to selecting a target object(s) to track, target object tracking module 229 uses transmitter beam determination module 235 to determine a configuration of the energy beam, such as a frequency, a modulation, an intensity, etc. In some embodiments, the transmitter beam configuration (e.g., frequency, modulation, intensity, etc.) is provided to the interceptor via modulating the energy beam or via a separate radio communication link or channel. In response to determining the configuration of the energy beam, target object tracking module 229 uses transmitter beam control module 237 to control transmitter module 233 to transmit the energy beam.

In some embodiments, target object tracking module 229 dynamically updates the list of target object to be tracked and dynamically determines whether to track a different target object, such as based on one or more of (i) the movement of the target object being tracked, (ii) a new target object being identified (which has a higher priority than the current target object being tracked), (iii) a change in the priorities for target objects, (iv) the target object being intercepted, (v) the target object moving outside certain restricted geographical zone, etc. In some embodiments, the updated list of target object is used to update instructions to one or more interceptors to indicate a movement to a new location related to a different or same object target. In various embodiments, the list adds new target objects, the list deletes target objects, or the list keeps target objects the same. In some embodiments, the list is determined or updated based at least in part on a target object risk assessment, a ranking of risk of one or more target objects, or any other appropriate factor for determining or updating the list.

In some embodiments, system 200 comprises target object selection module 231. System 200 uses target object selection module 231 to select one or more of the identified target objects. The selected target objects are to be tracked by system 200, such as by one or more of (i) modulating a single energy beam such that different modulations are directed at different selected target objects, (ii) duty cycling a single energy beam across multiple target objects of the selected target objects, and (iii) transmitting multiple energy beams (e.g., using multiple transmitter modules) and respectively directing the multiple energy beams to different target objects of the selected target objects.

In some embodiments, system 200 comprises transmitter module 233. System 200 uses transmitter module 233 to direct an energy beam towards one or more selected target objects. In some embodiments, the energy beam is an RF beam. The RF beam has a frequency (e.g., a cycle frequency) between 2 GHz and 50 GHz. In some embodiments, the frequency of the RF beam directed towards a target object is 20-40 GHz. In some embodiments, the frequency of the RF beam directed towards a target object is 20-35 GHz. In some embodiments, the frequency of the RF beam is about 24 GHz.

Transmitter module 233 configures and emits the energy beam based at least in part on a configuration provided by transmitter beam determination module 235 or transmitter beam control module 237. The energy beam is directed to the selected target object(s) to paint/illuminate the target object for a receiver (e.g., an interceptor) to receive energy scattered from the target object.

In some embodiments, system 200 comprises transmitter beam determination module 235. System 200 uses transmitter beam determination module 235 to determine a configuration for the energy beam(s) (e.g., RF beams) to be directed towards the applicable target object. Transmitter beam determination module 235 determines whether to configure the energy beam to duty cycle between multiple target objects, whether to modulate the energy beam to include additional information, and/or whether to modulate the energy beam to include modulations that are respectively to be directed to different target objects. Transmitter beam determination module 235 may further determine a location at which to direct the energy beam, such as based on a location and/or bearing of the applicable target object. Transmitter beam determination module 235 may dynamically or continuously update the configuration of the energy beam, such as based on movement of the applicable target object and/or selection of a different target object. Transmitter beam determination module 235 may provide the configurations for the energy beam to transmitter beam control module 237.

In some embodiments, system 200 comprises transmitter beam control module 237. System 200 uses transmitter beam control module 237 to control transmitter module 233 to direct the energy beam towards the target object(s) for the target object(s) to be tracked (e.g., by a receiver on an interceptor that detects scattered energy corresponding to the energy beam reflected by the target object).

In some embodiments, system 200 comprises user interface module 239. System 200 uses user interface module 239 in connection with configuring information (or the display thereof) to be provided to the user such as via administrator system 130 and/or client system 140 of system 100. In some embodiments, user interface module 239 configures a user interface to be displayed at a client terminal used by the user or administrator, such as an interface that is provided in a web browser at the client terminal. In some embodiments, user interface module 239 configures the information to be provided to the user such as configuring one or more reports of information that is responsive to a query or task executed with respect to a target object or a tracking of the target object.

According to various embodiments, storage 215 comprises one or more of file system data 260, transmission data 265, and/or target object library 270. Storage 215 comprises a shared storage (e.g., a network storage system) and/or database data, and/or target object activity data. In some embodiments, file system data 260 comprises a database such as one or more datasets (e.g., one or more datasets of sensor data, tracking data, etc.). In some embodiments, transmission data 265 comprises information pertaining to energy beams transmitted towards target objects, etc. In some embodiments, target object library 270 comprises information pertaining to one or more target objects or the tracking of target objects.

According to various embodiments, memory 220 comprises executing application data 275. In some embodiments, the application data comprises data for one or more applications that perform one or more of receiving and/or executing a query or request for object detection or object tracking. The one or more applications may include applications for configuring energy beams, controlling target detection, generating a report and/or configuring information that is responsive to an object detection or classification, and/or providing to a user information that is responsive to a query or request pertaining to object detection. Various other applications may be comprised in and executed by system 200.

FIG. 3 is a block diagram of a receiver system according to various embodiments of the present application. In some embodiments, system 300 implements at least part of system 100 of FIG. 1, such as interceptor system 160.

According to various embodiments, system 300 corresponds to, or comprises, a system for tracking an object, such as an object detected by a radar system. System 300 may be configured to detect a target object (e.g., based on scattered RF beams), approach a target object, intercept the target object, and/or perform an active measure with respect to the target object. Additionally, system 300 may determine an active measure and/or cause an active measure to be implemented in response to determining that an object is detected in sensor data or otherwise intercepted by an interceptor (e.g., an interceptor comprising system 300).

In the example shown, system 300 implements one or more modules in connection with performing object detection and providing tracking information for tracking the target object, etc. System 300 comprises communication interface 305, one or more processors 310, storage 315, and/or memory 320. One or more processors 310 comprises one or more of communication module 325, transmission beam detection module 327, target object identifying module 329, navigation module 331, interceptor-based tracking system module 333, active measure module 335, sensor module 337, intercepting module 339, and/or user interface module 341.

In some embodiments, system 300 comprises communication module 325. System 300 uses communication module 325 to communicate with various other systems, such as a seeker (e.g., system 200) or other system that paints/illuminates target objects using an energy beam. Communication module 325 may also communicate with client terminals or an administrator system. Communication module 325 provides to communication interface 305 information that is to be communicated. As another example, communication interface 305 provides to communication module 325 information received by system 300.

In some embodiments, communication module 325 receives information pertaining to an energy beam directed towards a target object(s) and/or information pertaining to a target object, such as target object bearing, target object type, target object identifier, etc. The information pertaining to the energy beam and/or target object may be received via one or more communication channels/links, such as based on communication between system 300 and an object tracking service (e.g., object tracking service 110 of system 100, system 200, etc.).

Communication module 325 may be configured to receive guidance information from an operations control service (e.g., a ground radar station or PTU). The guidance information may provide system 300 with the location of a target object, a bearing of the target object, and/or a general area or direction to which the interceptor (e.g., system 300) is to travel to obtain more specific location information or to be within range of a target object for system 300 to detect energy scatter reflected from the target object.

In some embodiments, system 300 comprises transmission beam detection module 327. System 300 uses transmission beam detection module 327 as a receiver to receive energy beams/signals, such as RF beams scattered from a target object. Transmission beam detection module 327 comprises one or more sensors and/or antennas. When the interceptor is within range of a target object to which an energy beam is directed by a transmitter, such as a ground station, transmission beam detection module 327 may detect scattered energy that is reflected from the target object(s). The scattered energy may be within a predefined frequency range. In some embodiments, the interceptor determines whether to begin using the scattered energy in connection with navigation when the interceptor is within a predefined back scatter range (e.g., about 2 km) of the target object. For example, the interceptor uses the scattered energy rather than guidance information provided by the radar station (e.g., a ground station that detects objects using radar or cameras, etc.).

In some embodiments, system 300 comprises target object identifying module 329. System 300 uses target object identifying module 329 to identify target objects or determine one or more characteristics pertaining to target objects. Examples of characteristics of target objects that are determined include: type, location, bearing, identifier, class, equipment, payload, etc. In some embodiments, target object identifying module 329 determines the target objects that the interceptor is to approach or intercept (e.g., the target objects selected to be tracked using system 200). Target object identifying module 329 identifies the target objects based on one or more of (i) scattered energy beams (e.g., RF beams) that are reflected from a target object(s), (ii) a communication channel/link established with a transmission station (e.g., system 200 of FIG. 2, or object tracking service 110 of FIG. 1), and/or (iii) sensor data obtained by on-board sensors (e.g., sensor module 337).

In some embodiments, system 300 comprises navigation module 331. System 300 uses navigation module 331 to determine a strategy for moving towards a target object(s), including determining a path to travel, a speed, etc. Navigation module 331 may control the interceptor to move in accordance with the strategy for moving towards a target object(s). Before the interceptor is within a predefined first range (e.g., ˜ 2 km), navigation module 331 controls the movement of the interceptor based on guidance provided by the object detection station (e.g., a ground station that uses object data detected by radar or camera, etc.). For example, navigation module 331 uses information that system 300 receives from the detection station to plan the strategy for approaching the target object. The information received from the detection station may include guidance information that specifies the location at which the interceptor is to travel to approach the target object. For example, the interceptor receives an indication to move to a designated target object. In some embodiments, the interceptor determines, based on the indication information (e.g., a target object's current position, speed, and heading), an initial heading and an initial speed for the interceptor to reach a volume of airspace surrounding the target object's current or projected location. In some embodiments, the interceptor receives periodic or as needed update indications to validate the or update the interceptor heading and speed to reach an appropriate volume of airspace surrounding the target object's updated current or updated projected location. In some embodiments, the interceptor (e.g., navigation module 331) determines whether the target object is within a scatter range to begin monitoring for a back scattered signal from the RF beam illuminating the target. Once within a scatter range and having detected a signal, navigation module determines whether the back scatter signal is strong enough and/or consistent enough to switch navigation control to drop the guidance determination from the tracking station (e.g., a detection system-basedinformation stream as received by system 300) and instead use the information from the back scattered signal. In some embodiments, the switch from one to the other guidance information is gradual—for example, system 300 uses guidance information from the tracking station, then a mix of information from the tracking station and the back scattered signal, then only from the back scattered signal. In some embodiments, in the event that the back scattered signal is lost, navigation module 331 of system 300 will transition back to using guidance information from the tracking station (e.g., camera detection system derived information—for example, a monostatic radar system, a bistatic radar system, a passive radar system, an imaging system, etc.).

Upon the interceptor coming within the predefined first range (e.g., ˜ 2 km, or such other distance that energy transmitted by a transmitter is scattered by a target object and detectable by system 300), navigation module 331 determines a strategy for moving the interceptor based on using (i) information obtained by the scattered energy detected by system 300, and/or (ii) information pertaining to the energy beam or target object received via a communication channel established between a transmission system (e.g., object tracking service 110) and the interceptor (e.g., system 300). For example, navigation module 331 detects, based at least in part on the scattered energy, a target object(s) painted/illuminated by a transmission system (e.g., object tracking system 114). In response to detecting the target object, navigation module 331 determines or updates a strategy for approaching the target object. For example, navigation module 331 causes the interceptor to fly towards the target object. Navigation module 331 may update the strategy in real-time or otherwise contemporaneous with receiving the scattered energy beam via a receiver or information pertaining to the energy beam or target object via a separate communication channel.

In some embodiments, as the interceptor comes within a close range of the target object, the interceptor switches from using the scattered energy in connection with navigation to using a low-powered radar system (e.g., interceptor-based tracking system module 333) on-board the interceptor. For example, in response to determining that the interceptor is within a predefined second range (e.g., ˜ 300 m or such other range associated with interceptor-based tracking system module 333), system 300 controls the interceptor to track the target object using the on-board low-power radar system and navigation module 331 uses information obtained by at least the on-board low-power radar system to determine/update the strategy for approaching the target object.

In some embodiments, system 300 comprises interceptor-based tracking system module 333. System 300 uses interceptor-based tracking system module 333 to track the target object when the interceptor is within a predefined second range of the target object being tracked. In some embodiments, the predefined second range is about 300 m or such other range of interceptor-based tracking system module 333.

In some embodiments, system 300 comprises active measure module 335. System 300 uses active measure module 335 to determine an active measure, if any, to be performed with respect to the target object. Examples of active measures include surveilling, collecting information using one or more sensors (e.g., cameras, infrared, UV, etc.) such as via sensor module 337, engaging the target object (e.g., with an interceptor payload), colliding with the target object, following the target object, etc. Active measure module 335 may determine an active measure based on instructions received from another system (e.g., object tracking service 110 or other administrator or control system) or based on a mapping of contexts to active measures. The mapping of contexts to active measures may be locally stored at the interceptor. Examples of mappings comprised in the mapping of contexts to active measures include an indication of an active measure to be performed based at least in part on a target object type, a target object identifier, a target object classification (e.g., friendly, civilian, enemy), a current path of the target object, a range of the target object to another predefined location or object, etc.

In some embodiments, active measure module 335 further determines when to perform the identified (e.g., selected) active measure and cause system 300 (or other system such as another interceptor or aircraft within range) to implement the active measure at such time or event. Active measure module 335 may dynamically update the plan for implementing the active measure (e.g., including selection of the applicable active measure) as the target object is tracked and contexts change.

In some embodiments, system 300 comprises sensor module 337. System 300 uses sensor module 337 to collect information associated with the target object being tracked or the interceptor. Examples of sensors include a force sensor, an infrared (IR) sensor, an ultraviolet (UV) sensor, a light sensor, a radar sensor, etc. System 300 may use sensor module 337 to collect doppler information or other information pertaining to the environment, which system 300 (e.g., navigation module 331) uses to remove/reduce ground clutter or other interference captured by system 300 such as via the collected scattered energy reflected off the target object. For example, system 300 (e.g., navigation module 331 or transmission beam detection module 327) pre-processes the collected information comprising the scattered RF beam to remove/reduce interference in the signal for more accurate determination of the location, bearing, or other information for the target object.

In some embodiments, system 300 comprises intercepting module 339. System 300 uses intercepting module 339 to intercept the target object. System 300 uses the strategy (e.g., path) for intercepting the target object, which is determined by navigation module 331, to control the interceptor to move in accordance with the strategy. For example, system 300 controls intercepting module 339 to move the interceptor according to the strategy. In some embodiments, the intercepting module 339 includes a motor, an engine, a propeller, a payload to be released, etc.

In some embodiments, system 300 comprises user interface module 341. System 300 uses user interface module 341 in connection with configuring information (or the display thereof) to be provided to the user such as via administrator system 130 and/or client system 140 of system 100. In some embodiments, user interface module 341 configures a user interface to be displayed at a client terminal used by the user or administrator, such as an interface that is provided in a web browser at the client terminal. In some embodiments, user interface module 341 configures the information to be provided to the user such as configuring one or more reports of information such as data pertaining to a target object or a tracking of the target object. A user may use user interface module 341 in connection with configuring the interceptor, such as to configure payloads, mappings of contexts to active measures, navigation modules, etc.

According to various embodiments, storage 315 comprises one or more of file system data 360, target object data 365, and/or target object library 270. Storage 315 comprises data used in connection with tracking a target object, such as a navigation module according to which navigation module 331 navigates the interceptor, settings/configurations of sensors, pre-processing algorithms or procedures to remove/reduce signal interference, etc. In some embodiments, file system data 360 comprises a database such as one or more datasets (e.g., one or more datasets of sensor data, tracking data, etc.). In some embodiments, target object data 365 comprises information pertaining to energy beams or other information received pertaining to a target object being tracked, etc. In some embodiments, target object library 370 comprises information pertaining to one or more target objects or the tracking of target objects.

According to various embodiments, memory 320 comprises executing application data 375. In embodiments, the application data comprises data for one or more applications that perform one or more of receive and/or execute a request or instruction for object detection or object tracking. The one or more applications may include applications for configuring receivers to detect energy beams, controlling the interceptor, generating a report and/or configuring information that is responsive to an object detection or classification, and/or providing to a user information that is responsive to a query or request pertaining to object detection. Various other applications may be comprised in and executed by system 300.

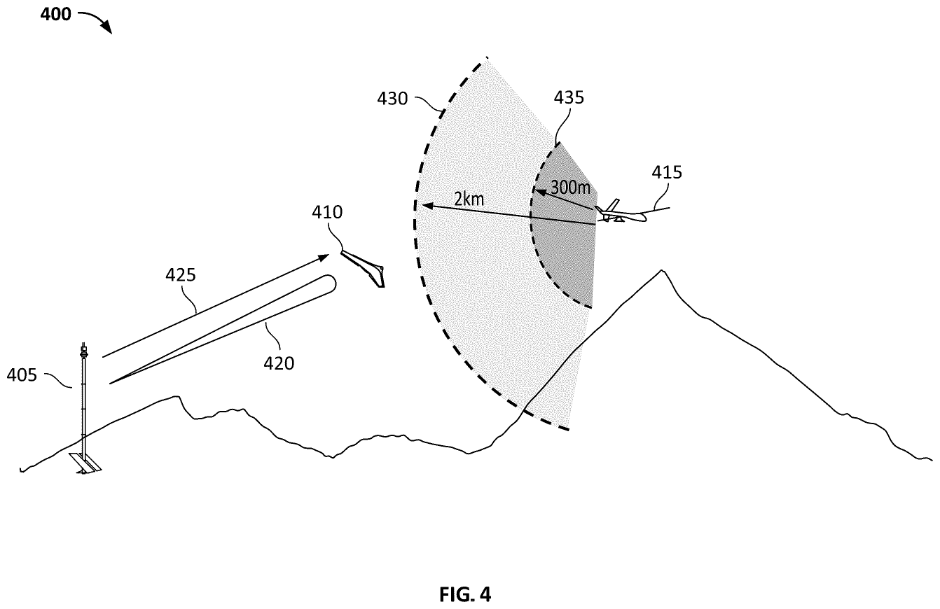

FIG. 4 is a diagram of a target tracking system according to various embodiments of the present application. In the example shown, system 400 comprises transmission system 405 and one or more interceptors, such as interceptor 410. System 400 is a bistatic radio wave localization that is configured to detect and track objects, such as target object 415.

System 400 uses a pan-tilt unit (PTU) (e.g., the PTU includes a radar system and/or a camera system) to detect an object and provide to interceptor 410 information pertaining to an object that system 400 determines to intercept/track. The PTU may be separate or integrated with transmission system 405 (e.g., a tracking station transmission system). In some embodiments, the PTU detects objects (e.g., within a predefined area) and interrogates the various detected objects to determine a set of target objects. The interrogating the detected objects may include determining whether a detected object is friendly, benign (e.g., a bird), civilian (e.g., a civilian drone, commercial aircraft), military, enemy, etc.

In response to determining the set of target objects, system 400 (e.g., transmission system 405) designates a target object (e.g., selected from the set of target objects) to be targeted. Transmission system 405 may designate the target object based at least in part on respective priorities for the set of target objects. For example, transmission system 405 assigns priorities to the various objects in the set of target objects, and selects the target object based on the respective priorities (e.g., system 400 selects the target object(s) having the highest priority).

In the example shown, system 400 designates the target object to be target object 415. In response to designating/selecting the target object, a PTU (e.g., tracking station comprising transmission system 405) provides guidance information to interceptor 410, which is selected to intercept/engage target object 415. The PTU guides interceptor 410 towards target object 415 until interceptor 410 is within predefined first range 430 or another range within which a receiver on interceptor 410 detects scattered energy reflected from target object 415. In some embodiments, predefined first range 430 is 2 km. However, various other predefined ranges may be implemented. The PTU may guide interceptor 410 via communication information pertaining to the target object (e.g., location, bearing, an identifier, etc.) to interceptor 410 via communication channel/link 425.

In response to interceptor 410 moving to within the first predefined range of target object 415, interceptor 410 uses an on-board receiver to detect energy being scattered by target object 415. In some embodiments, system 400 uses transmission system 405 to provide energy beam 420 directed towards target object 415. Transmission system 405 tracks target object 415 and updates energy beam 420 to continue to be directed at target object 415. In some embodiments, transmission system 405 further communicates to interceptor 410 information pertaining to energy beam 420 and/or target object 415. The information pertaining to energy beam 420 and/or target object 415 may be communicated via communication channel/link 425 and/or via modulation of energy beam 420.

In some embodiments, the energy beam is an RF beam having a frequency (e.g., a cycle frequency) between 2 GHz and 50 GHz. As an example, the higher the frequency of the RF beam, the greater the energy required to transmit the RF beam. In some embodiments, the frequency of the RF beam directed towards a target object is 20-40 GHz. In some embodiments, the frequency of the RF beam directed towards a target object is 20-35 GHz. In some embodiments, the frequency of the RF beam is about 24 GHz.

In some embodiments, the energy beam is optionally modulated to include additional information or to identify (e.g., paint/illuminate) another object. For example, the energy beam is modulated to carry information pertaining to a target object(s) and/or the energy beam, such as characteristics of the energy beam. As another example, the energy beam is modulated to identify multiple target objects with a particular energy beam directed from transmission system 405.

As interceptor 410 detects the scattered energy corresponding to energy beam 420 being scattered/reflected from target object 415, interceptor 410 tracks target object 415 by following the scattered energy. For example, transmission system 405 paints/illuminates target object 415 with a particular type of energy (e.g., an RF beam having a certain frequency or range of frequencies). Interceptor 410 may determine the type of energy (e.g., the frequency or range of frequencies) to follow based on the communication from transmission system 405 of the information pertaining to the energy (e.g., RF beam). Additionally, or alternatively, interceptor 410 may seek scattered energy having a predefined energy profile.

In response to detecting the scattered energy beam 420, interceptor 410 tracks target object 415 and approaches target object 415 or performs another active measure with respect to target object 415.

Interceptor 410 uses the scattering of energy beam 420 to track target object 415 and optionally navigate towards target object 415. When interceptor 410 moves within predefined second range 435 of target object 415, interceptor 410 may use an on-board detection system (e.g., a low-powered radar system) to detect and track target object 415. In some embodiments, predefined second range 435 is 300 m.

In some embodiments, the on-board detection system comprises an interior active array for low power integrated RF monolithic microwave integrated circuits (MMIC) to provide sufficient field of regard (FoR) at a short range (e.g., within 300 m) for final closing and tail chase of the target object. The on-board detection system is configured to have a 60 degree field of view. In some embodiments, the on-board detection system is configured to operate in the W band (e.g., 77 GHz). As an example, the range for the signal used by the on-board detection system is 350 m for −5 dBsm.

Interceptor 410 may be configured to perform an active measure with respect to target object 415, such as to surveil or eliminate target object 415. Interceptor 410 may autonomously determine whether to perform an active measure and cause the active measure to be implemented. For example, interceptor 410 stores a mapping of contexts to active measures and determines the particular active measure corresponding to the context of target object 415. Additionally, or alternatively, interceptor 410 is controlled to implement an active measure based on receipt of an instruction or other control signal from another system such as transmission system 405. For example, the instruction to implement the active measure may be communicated via communication channel/link 425.

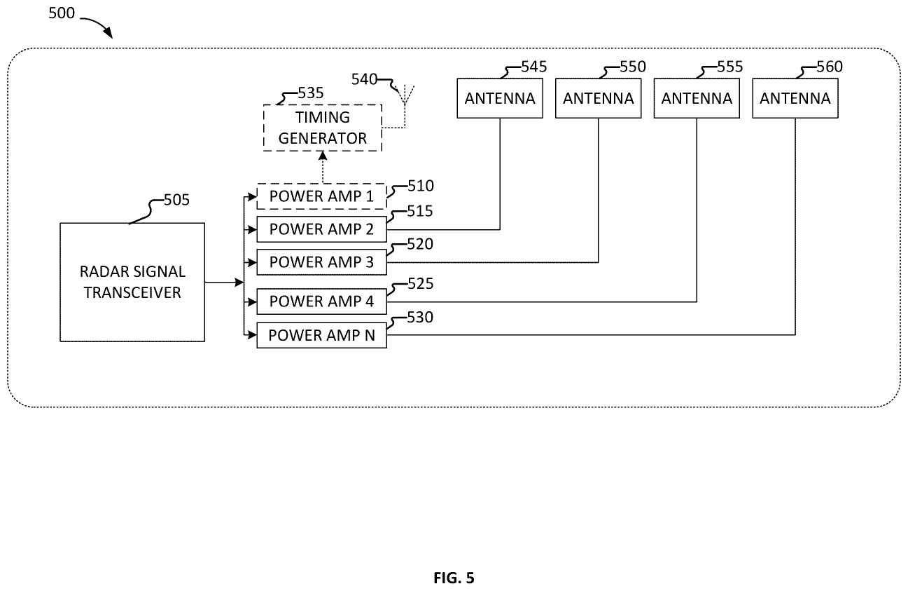

FIG. 5 is a diagram illustrating a bistatic radio wave localization transmitter according to various embodiments of the present application. In the example shown, bistatic radio wave localization transmitter 500 comprises signal transceiver 505, a plurality of power amplifiers (e.g., power amplifier 1 510, power amplifier 2 515, power amplifier 3 520, power amplifier 4 525, power amplifier N 530, etc.), timing generator 535, and a plurality of antennas (e.g., antenna 545, antenna 550, antenna 555, antenna 560, etc.). Bistatic radio wave localization transmitter 500 may use omni-directional antenna 540 to transmit a timing reference signal generated by timing generator 535.

In some embodiments, a transmission system (e.g., object tracking system 114, system 200, transmission system 405, etc.) uses bistatic radio wave localization transmitter 500 to transmit an energy beam having a frequency (e.g., a cycle frequency) between 2 GHz and 50 GHz. For example, bistatic radio wave localization transmitter 500 is configured to transmit energy beams in the K band (e.g., a frequency between 18 GHz and 27 GHz), which enables transmission over longer ranges using relatively smaller antennas. Bistatic radio wave localization transmitter 500 may be operated with a transmission power of about 40 W (e.g., 46 dBm).

Bistatic radio wave localization transmitter 500 is configured to transmit an energy beam having a field of view of less than 10 degrees. In some embodiments, the energy beam has a field of view less than 5 degrees. In some embodiments, the energy beam has a field of view of about 3 degrees.

In some embodiments, bistatic radio wave localization transmitter 500 is controlled to transmit a radio wave signal using a narrow beam pointed at the target object, such as by a PTU. Bistatic radio wave localization transmitter 500 may be configured to modulate the signal being transmitted. For example, bistatic radio wave localization transmitter 500 may be a Frequency Modulated Continuous Wave signal (FMCW) that is configured to modulate the signal. In some embodiments, the transmitted energy beam (e.g., RF transmitted beam) is modulated using one or more of the following: a frequency modulation, a phase modulation, an amplitude modulation, a shift modulation, and/or a chirp modulation.

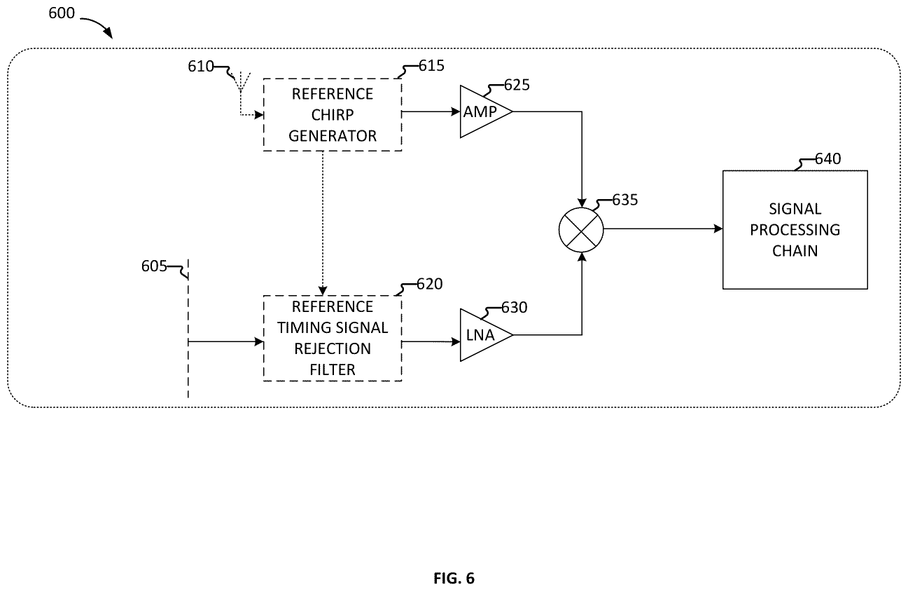

FIG. 6 is a diagram illustrating a local on-board radio detection system receiver according to various embodiments of the present application. In the example shown, on-board receiver 600 comprises antenna 605, reference chirp generator 615, reference timing signal rejection filter 620, amplifier 625, low noise amplifier (LNA) 630, mixer 635, and signal processing chain module 640.

Antenna 605 may be an array of antennas used to detect/receive energy beams or scattered energy corresponding to an energy beam (e.g., an RF transmitted beam).

Onboard receiver 600 comprises a field of view of 60 degrees. On-board receiver 600 may have an angular resolution of 2 degrees azimuth by 3 degrees of elevation.

Reference chirp generator 615 is configured to receive a timing reference signal (e.g., transmitted by a ground station or object tracking service) via omni-directional antenna 610.

On-board receiver 600 performs an angle of arrival estimation on signals (e.g., scattered energy) received from antenna 605. The estimation of the angle of arrival does not require synchronization between the transmitter and receiver. Rather, the estimation of the angle of arrival uses the relative phase relationship among signals from antenna 605. For example, only the relative phase relationship of received signals is required for a correct estimation of the direction.

In some embodiments, on-board receiver 600 performs azimuth and elevation measurements without a range or absolute doppler information. In some embodiments, on-board receiver 600 processes received signals for ground clutter elimination/reduction. For example, on-board receiver 600 implements relative doppler algorithms to process the received signals for ground clutter elimination/reduction.

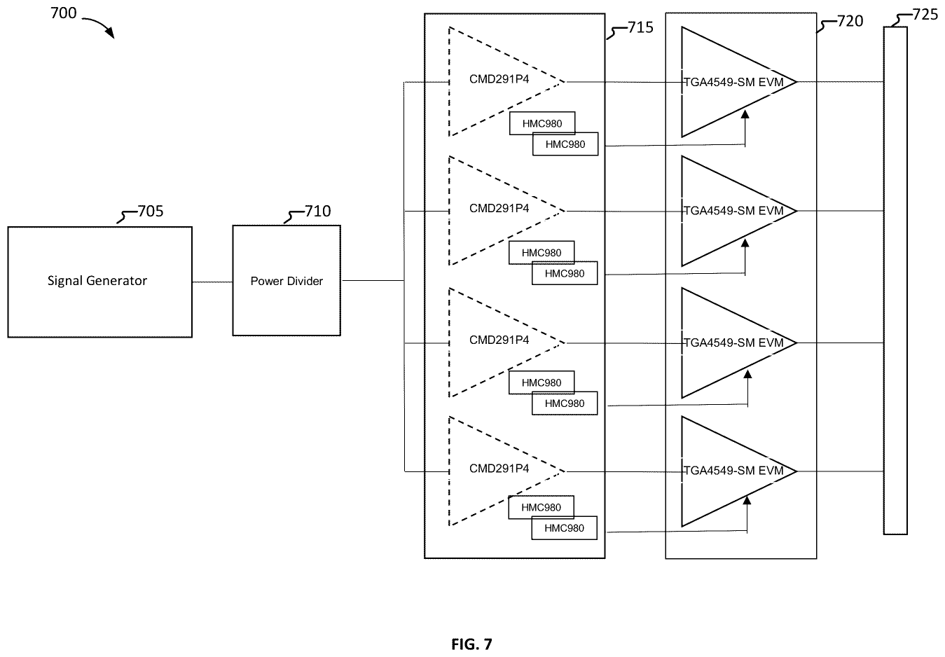

FIG. 7 is a diagram illustrating a bistatic radio wave localization transmitter according to various embodiments of the present application. In the example shown, bistatic radio wave localization transmitter 700 comprises signal generator 705, power divider 710, drive amplifier 715 with power and bias control, power amplifier 720, and antenna 725. In some embodiments, drive amplifier 715 is configured to have a power and bias control. As illustrated, drive amplifier 715 comprises a plurality of amplifiers and power amplifier 720 comprises a plurality of power amplifiers. In the example shown, signal generator 705 provides signals to power divider 710 which splits the signal to the plurality of amplifiers of drive amplifier 715 (e.g., CMD291P4 with bias controls HMC970). The drive amplifier 715 provides signals to the plurality of power amplifiers of power amplifier 720, which are provided to antenna 725.

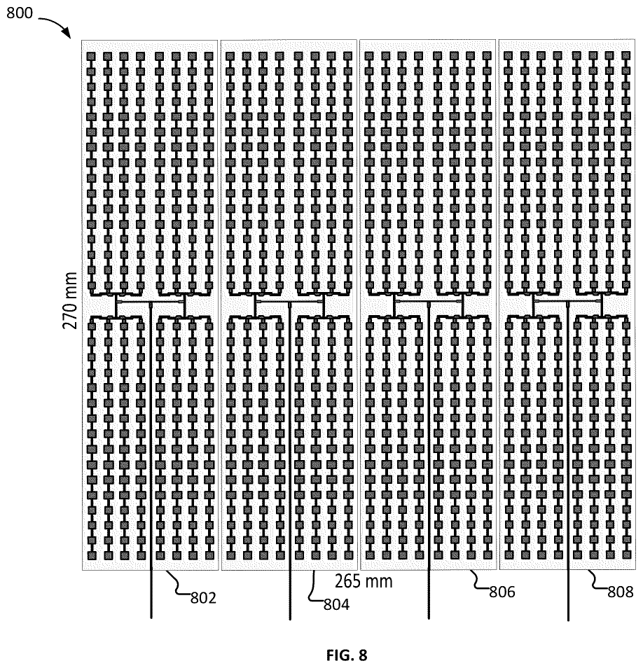

FIG. 8 is a diagram illustrating a bistatic radio wave localization transmitter antenna array according to various embodiments of the present application. In the example shown, transmitter 800 has a form factor of about 265 mm×270 mm. Transmitter 800 includes four groupings (e.g., group 802, group 804, group 806, and group 808) each with four arrays of conductor pads fed from the center of the grouping. The four groupings can be separately driven similar to an array of four dipole antennas. Each of the four arrays in turn have a set of four linear conducting pads (e.g., N pads in a line, where N is 16) on a top surface of a board. Transmitter 800 is configured to transmit signals within the K band, such as a band between 23.6 GHz to 24.25 GHz. In various embodiments, a transmitter antenna has different number of groupings, a different number of arrays, and a different number of linear conducting pads with a different number of pads in a line than what has been shown in FIG. 8 depending on the beam characteristics desired from the transmitter.

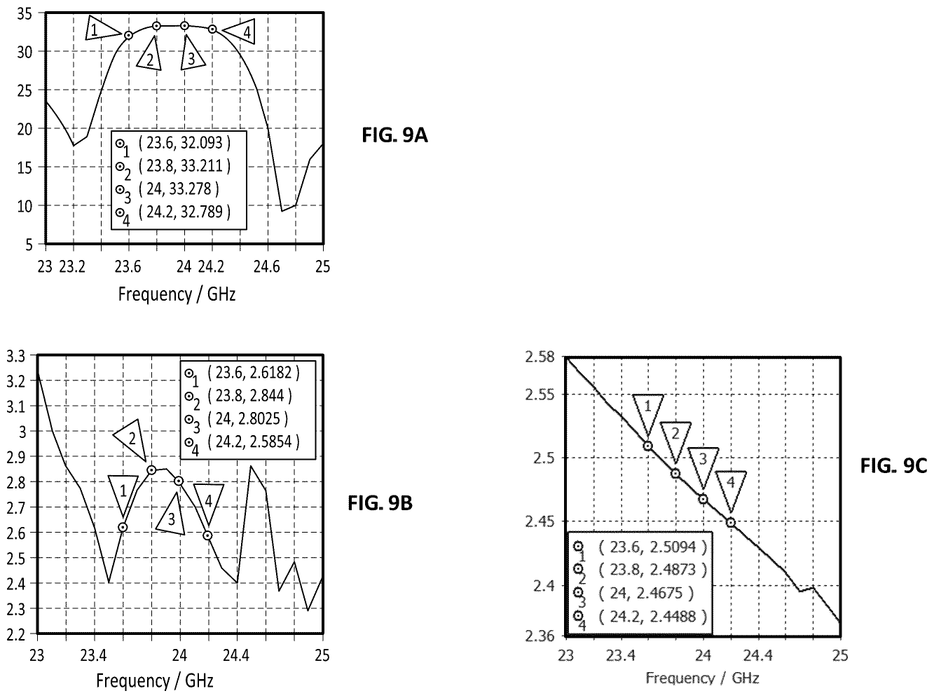

FIG. 9A is a diagram illustrating characteristics for a bistatic radio wave localization transmitter according to various embodiments of the present application. In the example shown, an antenna gain is depicted for a transmitter such as transmitter 800 of FIG. 8.

FIG. 9B is a diagram illustrating characteristics for a bistatic radio wave localization transmitter according to various embodiments of the present application. In the example shown, a 3 dB beam width in the E plane or vertical direction is depicted. The depicted beam width is for a beam transmitted by a transmitter such as transmitter 800 of FIG. 8.

FIG. 9C is a diagram illustrating characteristics for a bistatic radio wave localization transmitter according to various embodiments of the present application. In the example shown, a 3 dB beam width in the H plane or horizontal direction is depicted. The depicted beam width is for a beam transmitted by a transmitter such as transmitter 800 of FIG. 8.

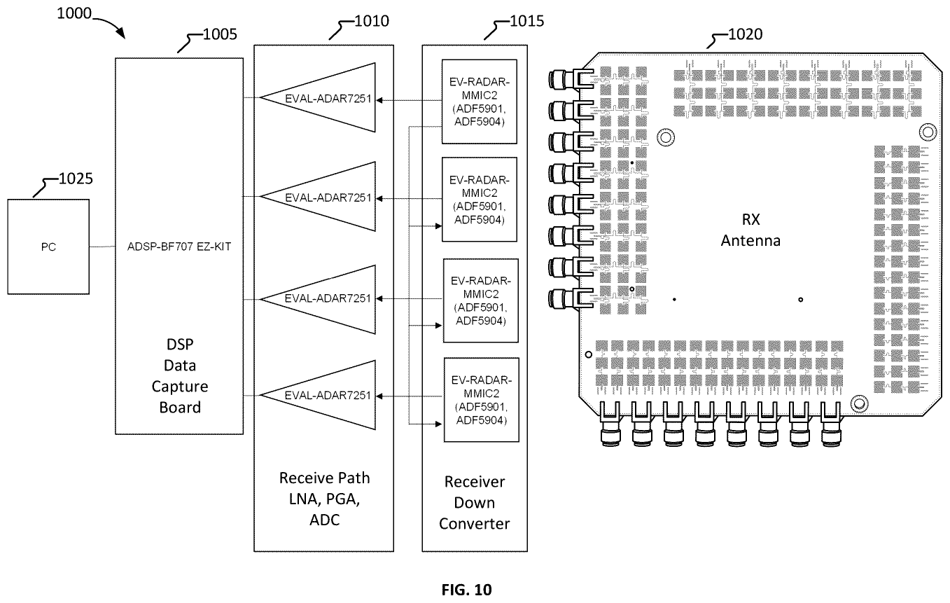

FIG. 10 is a diagram illustrating a receiver according to various embodiments of the present application. In the example shown, onboard receiver 1000 comprises digital signal processing data capture board 1005, receive path 1010, receiver down converter 1015, and antenna 1020. In some embodiments, receive path 1010 is configured to have a low noise amplifier (LNA), a programmable gain amplifier (PGA), and analog-to-digital converter (ADC). As illustrated, receiver down converter 1015 comprises a plurality of monolithic microwave integrated circuits (MMICs). Antenna 1020 receives signals on the plurality of conductor pads along the edges of a circuit board. The signals are processed using received down converter 1015 (e.g., ADF5904), passed to receive path 1010 (e.g., ADAR7251), and digital signal processing data capture board 1105 (e.g., ADSP-BF707). Digital signal processing data capture board 1005 passes output to a computer (e.g., personal computer (PC) 1125). In some embodiments, antenna 1020 is used for transmission as well using transmit MMICs (e.g., ADF5901).

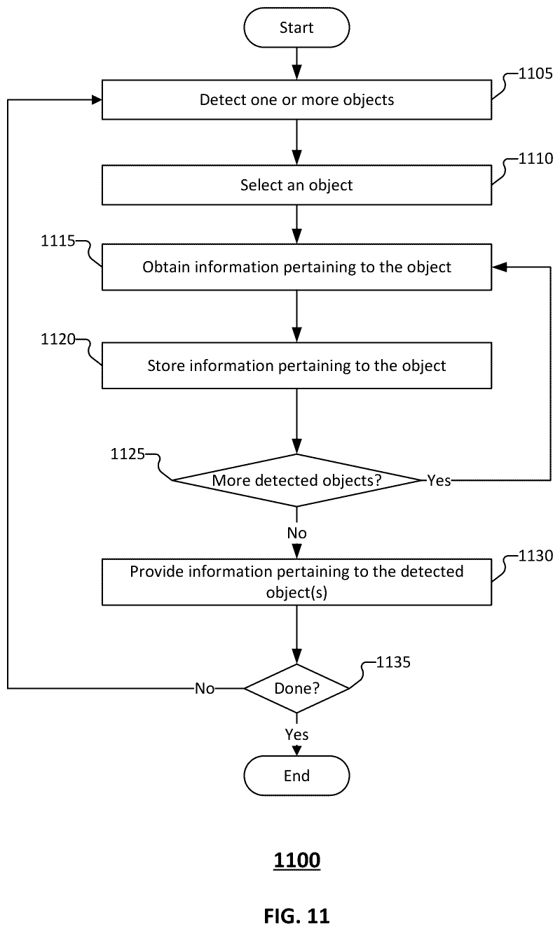

FIG. 11 is a flow diagram of a method for detecting objects according to various embodiments of the present application. In some embodiments, process 1100 is implemented at least in part by system 100 of FIG. 1.

At 1105, one or more objects are detected. The system uses a radar or camera to detect objects within a predefined area. In various embodiments, the radar or camera are part of a tracking station that is ground based, the radar or camera are based on a vehicle, an airborne vehicle, a seaborne vehicle or platform, or any other appropriate platform or vehicle. At 1110, an object is selected. In response to detecting one or more objects, the system selects an object such as for interrogation to classify the object (e.g., to determine whether the object is a target object to be tracked by the bistatic radio wave localization system). At 1115, information pertaining to the object is obtained. For example, the system obtains information for the selected object. Obtaining the information for the selected object may include determining an identifier for the object, an object type, an indication of whether the object is benign, friendly, or unfriendly, etc. The system may further obtain an object bearing, speed, etc. At 1120, information pertaining to the object is stored. At 1125, the system determines whether another detected object is to be interrogated. In response to determining that another detected object is to be interrogated at 1125, process 1100 returns to 1115 and iterates over 1115-1125 until no further detected objects are to be interrogated. In response to determining that no further detected objects are to be interrogated at 1125, process 1100 proceeds to 1130. At 1130, information pertaining to the detected object(s) is provided. For example, the information is provided to an interceptor, which is instructed to intercept the detected object. At 1135, a determination is made as to whether process 1100 is complete. In some embodiments, process 1100 is determined to be complete in response to a determination that the system has been provided to a transmitter of a bistatic radio wave localization system, no further objects are detected, a user has exited the system, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for tracking a target object according to various embodiments of the present application. In some embodiments, process 1200 is implemented at least in part by system 100 of FIG. 1 and/or system 200 of FIG. 2.

At 1205, information pertaining to a detected object(s) is obtained. As an example, the transmission system (e.g., bistatic radio localization system transmitter) obtains object information for an object detected by a detection system, such as objects detected at 1105 of process 1100. At 1210, a target object is determined. The system determines whether a detected object is a target object based at least in part on the information pertaining to the detected object. For example, the system determines that the object is a target object in response to determining that the object is unfriendly. For example, the system determines that the object is a target object based at least in part on an object bearing, object location, object speed, etc. At 1215, an RF transmitted beam is provided. In response to determining that an object is a target object, the system configures an energy beam to be directed towards the target object. The energy beam is a narrow beam that paints/illuminates the target object with a particular energy in order for a receiver in a bistatic radio localization system to detect the target object. At 1220, an indication regarding the RF transmitted beam and/or the target object is provided. The system provides the information pertaining to the RF transmitted beam and/or the target object to the receiver, such as by communicating such information over a channel between the system and the receiver or by modulating such information into the energy beam directed at the target object. At 1225, a determination is made as to whether process 1300 is complete. In some embodiments, process 1200 is determined to be complete in response to a determination that the interception of the detected objects is complete, no further objects are to be tracked, a user has exited the system, an administrator indicates that process 1200 is to be paused or stopped, etc. In response to a determination that process 1200 is complete, process 1200 ends. In response to a determination that process 1200 is not complete, process 1200 returns to 1205.

FIG. 13 is a flow diagram of a method for providing an indication regarding a radio frequency (RF) transmitted beam and/or a target object according to various embodiments of the present application. In some embodiments, process 1300 is implemented at least in part by system 100 of FIG. 1 and/or system 200 of FIG. 2. In some embodiments, process 1300 is invoked in connection with 1215 and 1220 of process 1200.

At 1305, information regarding the RF transmitted beam and/or the target object is obtained. At 1310, the RF transmitted beam is modulated to include information regarding the RF transmitted beam and/or the target object. At 1315, the RF transmitted beam is transmitted towards the target object. At 1320, a determination is made as to whether process 1300 is complete. In some embodiments, process 1300 is determined to be complete in response to a determination that the target object has been intercepted, no further objects are to be tracked or intercepted, a user has exited the system, an administrator indicates that process 1300 is to be paused or stopped, etc. In response to a determination that process 1300 is complete, process 1300 ends. In response to a determination that process 1300 is not complete, process 1300 returns to 1305.

FIG. 14 is a flow diagram of a method for providing an indication regarding an RF transmitted beam and/or a target object according to various embodiments of the present application. In some embodiments, process 1400 is implemented at least in part by system 100 of FIG. 1 and/or system 200 of FIG. 2. In embodiments, process 1400 is invoked in connection with 1220 of process 1200.

At 1405, information regarding the RF transmitted beam and/or the target object is obtained. At 1410, a communication channel is established with an interceptor. At 1415, the system sends to the interceptor the information regarding the RF transmitted beam and/or the target object. At 1420, a determination is made as to whether process 1400 is complete. In some embodiments, process 1400 is determined to be complete in response to a determination that the target object has been intercepted, no further objects are to be tracked or intercepted, a user has exited the system, an administrator indicates that process 1400 is to be paused or stopped, etc. In response to a determination that process 1400 is complete, process 1400 ends. In response to a determination that process 1400 is not complete, process 1400 returns to 1405.

FIG. 15 is a flow diagram of a method for tracking an object based at least in part on an RF transmitted beam transmitted by a transmitter according to various embodiments of the present application. In some embodiments, process 1500 is implemented at least in part by system 100 of FIG. 1 and/or system 300 of FIG. 3. Process 1500 may be implemented by a receiver in a bistatic radio wave localization system, such as an onboard receiver comprised in an interceptor.

At 1505, an indication regarding an RF transmitted beam and/or a target object is received. In some embodiments, the system (e.g., the receiver) obtains the information pertaining to the RF transmitted beam or the target object via a channel, such as a channel between a transmitter of the bistatic radio wave localization system and the receiver of the bistatic radio wave localization system. In some embodiments, the system obtains the information pertaining to the RF transmitted beam or the target object from the RF transmitted beam, such as from a modulation in the RF transmitted beam. At 1510, a scattered reflection of the RF transmitted beam is received from the target object. The system detects energy (e.g., parts of the RF transmitted beam) that is scattered from the target object. At 1515, the scattered reflection of the RF transmitted beam using the indication is processed. In response to receiving the scattered reflection of the RF transmitted beam, the system processes the RF transmitted beam such as in connection with determining a location of the target object. In some embodiments, the system pre-processes the scattered reflection of the RF transmitted beam to eliminate or reduce interference or noise, such as clutter reflected from the ground, etc. At 1520, the processed scattered reflection of the RF transmitted beam is provided using the indication. At 1525, a determination is made as to whether process 1500 is complete. In some embodiments, process 1500 is determined to be complete in response to a determination that the target object has been intercepted, no further objects are to be tracked or intercepted, a user has exited the system, an administrator indicates that process 1500 is to be paused or stopped, etc. In response to a determination that process 1500 is complete, process 1500 ends. In response to a determination that process 1500 is not complete, process 1500 returns to 1505.

FIG. 16 is a flow diagram of a method for controlling an interceptor based at least in part on an RF transmitted beam transmitted by a transmitter according to various embodiments of the present application. In some embodiments, process 1600 is implemented at least in part by system 100 of FIG. 1 and/or system 300 of FIG. 3.

At 1605, the system obtains information pertaining to the target object and/or the RF transmitted beam scattered from the target object. As an example, the system obtains such information from 1220 of process 1200. At 1610, a location or bearing of the target object is determined. The system determines the location or bearing of the target object based at least in part on the information pertaining to the target object and/or the RF transmitted beam scattered from the target object. At 1615, an interceptor is navigated based at least in part on the location or bearing of the target object. The system controls the interceptor to move in a direction or manner in order to intercept the target object or to perform an active measure with respect to the target object. At 1620, a determination is made as to whether process 1600 is complete. In some embodiments, process 1600 is determined to be complete in response to a determination that the target object has been intercepted, the interceptor is instructed to no longer track or intercept the target object, no further objects are to be tracked or intercepted, a user has exited the system, an administrator indicates that process 1600 is to be paused or stopped, etc. In response to a determination that process 1600 is complete, process 1600 ends. In response to a determination that process 1600 is not complete, process 1600 returns to 1605.

FIG. 17 is a flow diagram of a method for performing an active measure with respect to a target object being tracked by a bistatic radio wave localization system according to various embodiments of the present application. In some embodiments, process 1700 is implemented at least in part by system 100 of FIG. 1 and/or system 300 of FIG. 3.

At 1705, the system obtains information pertaining to a scattered RF transmitted beam and/or a target object.

At 1710, a range to the target object is determined. The system determines the range or location of the target object based at least in part on the scattered RF transmitted beam or the information pertaining to a scattered RF transmitted beam and/or a target object.

At 1715, an interceptor is navigated based at least in part on information pertaining to a scattered RF transmitted beam and/or a target object.

At 1720, the system determines whether the range to the target object is less than or equal to a threshold range. In response to determining that the range is not less than or equal to the threshold range at 1720, process 1700 returns to 1705 and iterates over 1705-1720 until the range to the target object is less than or equal to the threshold range. In response to determining that the range to the target object is less than or equal to the threshold range at 1720, process 1700 proceeds to 1725.

At 1725, information pertaining to the target object is determined based at least in part on an on-board radar. For example, the system uses a low power radar (e.g., having a smaller range, such as less than 500 m) to determine the location of the target object, the target object bearing, etc.

At 1730, an interceptor is navigated based at least in part on feedback from the on-board radar. The system detects feedback (e.g., reflected energy beams) from the target object, and the system determines the location of the target object, the target object bearing, etc. The system navigates the interceptor based at least in part on the location of the target object or other information determined from the feedback from the target object.

At 1735, the system determines whether to perform an active measure. In response to determining that an active measure is not to be performed at 1735, process 1700 returns to 1725 and iterates over 1725-1735 until the system determines that an active measure is to be performed. In response to determining that an active measure is to be performed at 1735, process 1700 proceeds to 1740.

At 1740, an active measure is performed. The system may implement the active measure or cause the active measure to be performed.

At 1745, a determination is made as to whether process 1700 is complete. In some embodiments, process 1700 is determined to be complete in response to a determination that the target object has been intercepted or eliminated, the interceptor is instructed to no longer track or intercept the target object, no further objects are to be tracked or intercepted, a user has exited the system, an administrator indicates that process 1700 is to be paused or stopped, etc. In response to a determination that process 1700 is complete, process 1700 ends. In response to a determination that process 1700 is not complete, process 1700 returns to 1705.

FIG. 18 is a flow diagram illustrating an embodiment of a process for determining guidance of an interceptor. In some embodiments, the process 1800 is implemented at least in part by system 100 of FIG. 1 and/or system 300 of FIG. 3. In the example shown, in 1805, an indication is received to intercept a target object from a tracking station. For example, a detection system comprising one or more of a monostatic radar system, a bistatic radar system, a passive radar system, an imaging system, a visual camera, a lidar system, an infrared detection system is/are used to determine a target object and the system determines whether the target object is to be tracked. In 1810, navigation to the target is determined based on the indication information. For example, the location and/or heading information from the detection system is used to determine an intercept navigation course. In 1815, it is determined whether the range to the target object is less than or equal to a scatter range. In response to the range to the target object being not less than or equal to the scatter range, control passes to 1810. In response to the range to the target object being less than or equal to the scatter range, control passes to 1820. In some embodiments, 1815 is omitted and the process flows directly from 1810 to 1820. In 1820, it is determined whether the scatter signal is greater than or equal to a threshold. In response to the scatter signal not being greater than or equal to a threshold, control passes to 1810. In response to the scatter signal being greater than or equal to a threshold, control passes to 1825. In 1825, navigation to the target object is determined using scattered energy and/or tracking station information. In some embodiments, in response to the scatter energy being greater than or equal to the scatter threshold, determine the navigation to the target object based at least in part on 1) the scatter energy or 2) the scatter energy and the indication from the tracking station. In 1830, it is determined whether the range to the target object is less than or equal to a closing range. In response to the range to the target object being not less than or equal to the closing range, control passes to 1820. In response to the range to the target object being less than or equal to the closing range, control passes to 1835. In some embodiments, 1830 is not performed and the process flows directly from 1825 to 1835 or the process flows directly from 1845 to 1835. In 1835, it is determined whether the on-board tracking signal is greater than or equal to a threshold. In response to the on-board tracking signal not being greater than or equal to a threshold, control passes to 1820. In response to the scatter signal being greater than or equal to a threshold, control passes to 1840. In 1840, navigation to the target object is determined using scattered energy and/or on-board tracking. In some embodiments, navigation to the target is based at least in part on 1) the on-board tracking signal or 2) the on-board tracking signal and the scatter energy. In 1845 it is determined whether to perform an active measure. For example, it is determined whether the indication to intercept target included instruction for an active measure and the type of active measure to be performed. In response to not determining to perform an active measure, control passes to 1830. In response to determining to perform an active measure, control passes to 1850. In 1850, and active measure is performed. In various embodiments, the active measure comprises one or more of the following: providing an indication that an object is detected, surveilling the target object, eliminating the target object, intercepting the target object, jamming sensors comprised in the target object, or any other appropriate active measure. In 1855, it is determined whether interception with a target object is done. In response to determining that interception with a target object is not done, control passes to 1805. In response to determining that interception with a target object is done, the process ends.

In some embodiments, in the event that an on-board tracking signal goes away, the system falls back to the scattered energy signal for tracking. In some embodiments, in the event that the scattered energy signal for tracking goes away, the system falls back to the indication from the tracking station (e.g., monostatic radar, bistatic radar, passive radar, imaging system, etc.).

Various examples of embodiments described herein are described in connection with flow diagrams. Although the examples may include certain steps performed in a particular order, according to various embodiments, various steps may be performed in various orders.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a receiver, wherein the receiver is configured to:
receive an indication regarding a radio frequency (RF) transmitted beam;
receive a scattered reflection of the RF transmitted beam from a first target object; and
process the scattered reflection of the RF transmitted beam using the indication.

2. The system of claim 1, wherein the receiver is comprised in an interceptor.

3. The system of claim 2, wherein the interceptor is airborne.

4. The system of claim 2, wherein the interceptor is configured to navigate based at least in part on the scattered reflection of the RF transmitted beam.

5. The system of claim 4, wherein the interceptor navigates based on following or tracking the scattered reflection of the RF transmitted beam.

6. The system of claim 4, wherein the interceptor navigates to intercept or move within a is predefined range of the first target object.

7. The system of claim 4, wherein the interceptor switches to navigation based on an onboard directional radar in response to determining that the interceptor is within a predefined distance of the first target object.

8. The system of claim 1, wherein the RF transmitted beam comprises an energy beam.

9. The system of claim 8, wherein the energy beam comprises a beam with a carrier frequency of 2-50 GHz.

10. The system of claim 8, wherein the RF transmitted beam is modulated.

11. The system of claim 10, wherein the RF transmitted beam is modulated using one or more of the following: a frequency modulation, a phase modulation, an amplitude modulation, a shift modulation, a chirp modulation.

12. The system of claim 10, wherein a first modulation of the RF transmitted beam is directed to the first target object, and a second modulation of the RF transmitted beam is directed to a second target object.

13. The system of claim 10, wherein the RF transmitted beam is modulated to comprise information regarding the RF transmitted beam or the first target object.

14. The system of claim 1, wherein the indication includes one or more of: RF transmitted beam modulation information, a target bearing, and a target distance.

15. The system of claim 1, wherein processing the scattered reflection of the RF transmitted beam comprises determining one or more of a relative target bearing and a relative target distance.

16. The system of claim 1, wherein processing the scattered reflection of the RF transmitted beam comprises filtering based at least in part on Doppler analysis to isolate a signal from the first target object.

17. The system of claim 1, wherein the receiver has a field of view between 30 degrees and 60 degrees.

18. The system of claim 1, wherein the receiver is configured to receive, via a communication channel established with a transmitter associated with transmission of the RF transmitted beam, an indication of information regarding the RF transmitted beam or the first target object.

19. A method, comprising:
receiving, by a receiver, an indication regarding a radio frequency (RF) transmitted beam;
receiving a scattered reflection of the RF transmitted beam from a first target object; and
processing the scattered reflection of the RF transmitted beam using the indication.

20. A computer program product embodied in a non-transitory computer readable medium and comprising computer instructions for:
receiving, by a receiver, an indication regarding a radio frequency (RF) transmitted beam;
receiving a scattered reflection of the RF transmitted beam from a first target object; and
processing the scattered reflection of the RF transmitted beam using the indication.
